(19) United States
(12) Patent Application Publication
(10) Pub. No.: US 2023/0219318 A1
(43) Pub. Date: Jul. 13, 2023

(54) BREATHABLE FILM

(71) Applicant: Tama Group, Kibbutz Mishmar Haemek (IL)

(72) Inventors: Reuven HUGI, Nahariya (IL); Hagai PAZ, Kibbutz Mishmar HaEmek (IL); Ran COHEN, Kibbutz Galed (IL); Yori COSTA, Kibbutz Mishmar HaEmek (IL)

(21) Appl. No.: 18/122,282

(22) Filed: Mar. 16, 2023

Related U.S. Application Data
(63) Continuation of application No. PCT/IL2021/051132, filed on Sep. 15, 2021.
(60) Provisional application No. 63/079,569, filed on Sep. 17, 2020.

(51) Int. Cl. B32B 3/26; B65D 65/40; B65D 81/26; B32B 27/32; B32B 27/18; B32B 27/08; C08J 7/054; C08J 7/06

(52) U.S. Cl. CPC B32B 3/266; B65D 65/40; B65D 81/263; B32B 27/32; B32B 27/18; B32B 27/08; C08J 7/054; C08J 7/06; B32B 2307/724; B32B 2307/7265; B32B 2307/538; B32B 2307/73; B32B 2255/20; B32B 2255/10; B32B 2307/7376; B32B 2307/308; B32B 2307/54; B32B 2439/00; B32B 2250/24; B32B 2250/02; C08J 2323/06

(57) ABSTRACT

A film comprising a perforated layer, wherein the perforated layer is characterized by water vapor transmission rate (WVTR) of at least 300 gr/m2/day; and wherein the perforated layer is characterized by a liquid permeability of less than 0.6 gr when measured according to AATCC 35. Further, methods of manufacturing the composition of the invention are provided.

### CROSS REFERENCE TO RELATED APPLICATIONS

This application is a Bypass Continuation of PCT Application No. PCT/IL2021/051132 having International filing date of Sep. 15, 2021, which claims the benefit of priority under 35 USC § 119(e) of U.S. Provisional Patent Application No. 63/079,569, filed Sep. 17, 2020 titled “BREATHABLE FILM”, the contents of which are all incorporated herein by reference in its entirety.

### FIELD OF THE INVENTION

The invention relates generally to the field of perforated polymeric layers.

### BACKGROUND

A flat surface of pure polypropylene has a contact angle with water (wetting angle) of about 90-100°. This contact angle, which lies in the gray zone between hydrophilicity and hydrophobicity, is reflected in the mediocre water-repellent properties of nonwoven fabrics made of polypropylene fibers. In general, one distinguishes between two main types of hydrophobicity in polymeric materials. The first type is a measure of the water-repellent properties of one material while the other is a measure of resistance to permeability. Water permeability of a material is divided into two types of permeability. The permeability to liquid water and the permeability to water vapor due to the diffusion of water molecules. The degree of permeability to liquid water depends on the pore radius, the wetting angle, the degree of sublimation and defects in the material. For polypropylene nonwovens, the two types of hydrophilicity are often not completely independent of each other. An increase in water repellency is often synonymous with a decrease in permeability and vice versa.

There is a need for a packaging material, providing both a water-repellent property and water vapor permeability.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

In one aspect, there is a film comprising a perforated layer, wherein at least 95% of openings within the perforated layer are of a diameter of less than 60 μm; wherein a surface area of the openings is between 0.006 and 10% of the total surface area of the perforated layer; the perforated layer is characterized by water vapor transmission rate (WVTR) of at least 300 gr/m2/day; and wherein the perforated layer is characterized by a liquid permeability of less than 0.6 gr when measured according to AATCC 35.

In one embodiment, the perforated layer is in contact with an additional layer.

In one embodiment, the perforated layer comprises a thermoplastic polymer.

In one embodiment, the thermoplastic polymer comprises a polyolefin.

In one embodiment, (i) at least 95% of openings have a diameter of less than 25 μm, (ii) a contact angle of an outer surface of the perforated layer is more than 115°, (iii) a sliding angle of the outer surface of the perforated layer is less than 35°, or any combination of (i), (ii), and (iii).

In one embodiment, at least a part of the outer surface of the perforated layer is characterized by a surface roughness of between 1 nm and 10 μm.

In one embodiment, at least a part of the outer surface of the perforated layer comprises a hydrophobic coating.

In one embodiment, the perforated layer is in a form of a film.

In one embodiment, the perforated layer is between 10 and 200 μm thick.

In one embodiment, the perforated layer is stable: (a) at a temperature between −25 to 75° C.; and (b) for at least 12 months upon exposure to UV radiation of 180 kilo Langley per year (KLy p.a.).

In one embodiment, the perforated layer is characterized by elongation at break between 10 and 1000%.

In one embodiment, the perforated layer is characterized by tensile strength at break between 5 and 50 N/10 mm.

In one embodiment, the perforated layer comprises at least 10 openings per square centimeter.

In one embodiment, the perforated layer further comprises an additive.

In another aspect, there is a method of manufacturing the film of the invention, comprising (i) providing a perforated polymeric layer having an outer surface and an inner surface, wherein the perforated polymeric layer comprises a plurality of openings having a diameter of less than 60 μm; and at least one of: (a) contacting the outer surface of the perforated polymeric layer with a plurality of hydrophobic particles under conditions suitable for binding the plurality of hydrophobic particles to the outer surface; and (b) exposing the perforated polymeric layer to any of embossing, thermal irradiation, microwave irradiation, infra-red irradiation, and UV-visible irradiation, or any combination thereof; thereby obtaining the outer surface of the perforated polymeric layer having a contact angle of more than 115° and a sliding angle of less than 35°.

In one embodiment, the hydrophobic coating comprises a plurality of hydrophobic particles.

In one embodiment, the plurality of hydrophobic particles comprises any one of: silica, a hydrophobic titanium oxide, a hydrophobic zinc oxide, and a nano-clay or any combination thereof.

In one embodiment, the silica comprises a chemically-modified silica.

In another aspect, there is an article comprising the film the invention.

In one embodiment, the article is characterized by a) water vapor transmission rate (WVTR) of at least 300 gr/m2/day, b) a liquid permeability of less than 0.6 gr when measured according to AATCC 35, or by a) and b).

In one embodiment, the article being in a form of a packaging material or a packaging article.

In addition to the exemplary aspects and embodiments described above, further aspects and embodiments will become apparent by reference to the figures and by study of the following detailed description.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is an image representing a water droplet in contact with the superhydrophobic layer of the invention.

FIGS. 2A-C are confocal microscopy images and a profile of the hydrophobic surface on an exemplary film of the invention obtained using a microscope and a profilometer. FIG. 2A is a colored image and FIG. 2B is a black and white image showing a topographic surface map of the hydrophobic surface. The scale bar (right) represents a distribution of micrometer-sized peak heights and crater depths. FIG. 2C is a graph representing a profilometer surface analysis in MD direction.

FIGS. 3A-C are Scanning Electron Microscope (SEM) top view images of an exemplary perforated polyethylene-based film of the invention coated with hydrophobic silica nanoparticles at different magnitudes. White arrow points toward an opening at the rim of the crater.

### DETAILED DESCRIPTION

According to one aspect there is provided a composition comprising a perforated layer, wherein at least 95% of openings within the perforated layer are of a diameter of less than 60 μm; and wherein a surface area of the openings is between 0.006 and 10% of the total surface area of the perforated layer. According to another aspect, there is provided a film comprising a perforated layer, wherein at least 95% of openings within the perforated layer are of a diameter of less than 60 μm; and wherein a surface area of the openings is between 0.006 and 10% of the total surface area of the perforated layer.

### Water Impermeable Layer

In some embodiments, the perforated layer comprises a plurality of openings which are substantially liquid impermeable. In some embodiments, the perforated layer is liquid impermeable. In some embodiments, the perforated layer is a water impermeable layer. In some embodiments, a diameter of openings is less than a diameter of a water drop. In some embodiments, the perforated layer is in a form of a film. In some embodiments, the perforated layer is in a form of a polymeric film.

As used herein, the term “water impermeable” relates to permeability of the perforated layer to a liquid (such as water or an aqueous solution), when measured according to AATCC 35. Without being bound to any particular theory or mechanism, the perforated layer comprising openings having a diameter of less than 25 μm substantially prevents liquid from passing through the perforated material. In some embodiments, the liquid is a polar liquid comprising an alcohol (such as ethanol, methanol, and isopropanol), water, an aqueous solution or a combination thereof.

In some embodiments, the water impermeable layer is characterized by water permeability of less than 0.5 gr, when measured according to AATCC 35. In some embodiments, water permeability of the perforated layer is less than 0.5 gr, less than 0.3 gr, less than 0.2 gr, less than 0.1 gr, less than 0.01 gr, including any range or value therebetween.

In some embodiments, the water impermeable layer is a polymeric layer. In some embodiments, the water impermeable layer is film (e.g. a polymeric film).

In some embodiments, at least 85%, at least 90%, at least 92%, at least 95%, at least 96%, at least 97%, at least 98%, at least 99% of openings have a diameter of less than 25 μm. In some embodiments, the plurality of openings have a diameter of at least 20 μm, at least 19 μm, at least 18 μm, at least 17 μm, at least 16 μm, at least 15 μm, at least 13 μm, at least 10 μm, at least 8 μm, at least 5 μm, at least 3 μm, at least 2 μm, at least 1 μm, including any range or value therebetween.

In some embodiments, the water impermeable layer is substantially devoid of openings having a diameter of more than 20 μm. In some embodiments, a percentage of openings having a diameter of more than 20 μm is less than 10%, less than 8%, less than 5%, less than 3%, less than 2%, less than 1%, less than 0.5%, less than 0.1%, less than 0.01%, including any range or value therebetween.

In some embodiments, the plurality of openings has a diameter in a range between 1 and 25 μm, between 1 and 20 μm, between 1 and 17 μm, between 1 and 15 μm, between 1 and 10 μm, between 1 and 5 μm, between 10 and 20 μm, between 10 and 13 μm, between 10 and 17 μm, between 13 and 17 μm, between 15 and 20 μm, between 10 and 15 μm, including any range or value therebetween.

In some embodiments, a value of the diameter is a mean value. In some embodiments, a standard deviation of the diameter value is between 0.1 and 5 μm, between 0.1 and 0.5 μm, between 0.5 and 1.5 μm, between 0.5 and 1 μm, between 1 and 1.5 μm, between 1.5 and 2 μm, between 2 and 3 μm, between 3 and 4 μm, between 4 and 5 μm, including any range or value therebetween.

In some embodiments, a standard deviation of the diameter value is at most 7 μm, at most 6 μm, at most 5.5 μm, at most 5 μm, at most 4.5 μm, at most 4 μm, at most 3 μm, at most 2 μm, at most 1 μm, at most 0.5 μm, including any range or value therebetween.

In some embodiments, the water impermeable layer is substantially devoid of openings having a diameter greater than 20 μm, greater than 25 μm, greater than 30 μm, greater than 35 μm, greater than 40 μm, including any range or value therebetween. In some embodiments, a percentage of openings having a diameter greater than 20 μm or greater than 25 μm within the water impermeable layer is less than 5%, less than 4%, less than 3%, less than 2%, less than 1%, less than 0.5%, less than 0.1%, less than 0.01%, less than 0.05%, including any range or value therebetween.

In some embodiments, the plurality of openings is characterized by any geometric form or shape. In some embodiments, the plurality of openings has substantially round shape or substantially elliptical shape. In some embodiments, the plurality of openings has an irregular shape. In some embodiments, the plurality of openings has a random shape. In some embodiments, the plurality of openings is in a form of holes or perforations.

In some embodiments, at least a part of the plurality of openings is characterized by a linear shape. In some embodiments, at least a part of the plurality of openings has a slot geometry. In some embodiments, the plurality of openings has an elongated shape (e.g. a linear shape) having a width of less than 30 μm, less than 20 μm, less than 25 μm, less than 15 μm, less than 10 μm, less than 5 μm, including any range or value therebetween. In some embodiments, the plurality of openings being characterized by a linear shape have a length of 30 to 1000 μm, 20 to 30 μm, 30 to 50 μm, 50 to 70 μm, 70 to 100 μm, 100 to 200 μm, 200 to 300 μm, 300 to 400 μm, 400 to 500 μm, 500 to 600 μm, 600 to 800 μm, 800 to 1000 μm, including any range or value therebetween.

In some embodiments, the plurality of openings forms a pattern on or within the wall. In some embodiments, the pattern is a specific pattern. In some embodiments, the openings are provided in a pattern of distinct groups within the polymeric layer. In some embodiments, the pattern of distinct groups or clusters of openings may be either random or regular; in either instance the openings in each distinct group or cluster may be randomly distributed therein.

In some embodiments, the opening is configured to support transmission or diffusion of water vapors across the polymeric layer or of the polymeric film. In some embodiments, the opening enhances a transmission or diffusion of water vapors through at least a portion of the polymeric layer or of the polymeric film.

In some embodiments, at least 85%, at least 90%, at least 92%, at least 95%, at least 96%, at least 97%, at least 98%, at least 99% of openings have substantially round shape or substantially elliptical shape. In some embodiments, substantially round-shaped holes are characterized by a shape factor (SF) of 1 to 100. In some embodiments, the plurality of openings has a coefficient of variation of SF between 10 and 50%.

In some embodiments, the openings are irregular in shape. In some embodiments, the openings do not assume a clearly identifiable geometric configuration such as circular, square or oval.

As used herein, the term “shape” is referred to a contour (e.g. perimeter) of a hole.

Shape Factor is an indication of the roundness of a hole or opening in a material being tested. Shape Factor (SF) is defined by the formula: P²KA where P is the perimeter of the hole or opening being measured, A is the area of the hole or opening and K is a constant. For a hole or opening which is perfectly circular in configuration, the Shape Factor, SF, is unity, i.e. 1. The higher the value of the Shape Factor, the more irregular, i.e. the less circular, is the configuration of the hole or opening.

In some embodiments, the openings and are randomly distributed within the water impermeable layer. In some embodiments, the openings form a specific pattern within the water impermeable layer. In some embodiments, the openings are provided in a pattern of distinct groups within the water impermeable layer. In some embodiments, the pattern of distinct groups or clusters of openings may be either random or regular; in either instance the openings in each distinct group or cluster may be randomly distributed therein. In some embodiments, at least a portion of the openings is in contact with at least one additional opening. In some embodiments, at least a portion of the perimeter or edge of an opening is in contact with at least a portion of the perimeter or edge of an additional opening. In some embodiments, at least a portion of the openings is distant form each other. In some embodiments, at least a portion of the openings is devoid of contact one with each other.

In some embodiments, the openings in the specific pattern are arranged in rows running crosswise of the polymeric layer and in columns running lengthwise of the polymeric layer.

An “elliptical shape” as used herein, is characterized by a minor axis and a major axis. In some embodiments, the diameter of an elliptically shaped opening is referred to a minor axis.

As used herein, the term “opening” relates to a hole, perforation or an aperture.

In some embodiments, the water impermeable layer comprises at least 10, at least 20, at least 30, at least 40, at least 50, at least 60, at least 70, at least 80, at least 90, at least 95, at least 100, at least 105, at least 110, at least 115, at least 120, at least 130, at least 135, at least 140, at least 145, at least 150, at least 155, at least 160, at least 165, at least 170, at least 175, at least 180, at least 190, at least 200, at least 210, at least 220, at least 230, at least 240, at least 250, at least 260, at least 270, at least 280, at least 290, at least 300, at least 310, at least 320, at least 330, at least 340, at least 350, at least 370, at least 390, at least 400, at least 500, at least 600, at least 700, at least 800, at least 1000, at least 2000, at least 3000, at least 4000, at least 5000 openings per square centimeter including any value therebetween.

In some embodiments, the water impermeable layer comprises between 50 and 200, between 50 and 60, between 60 and 70, between 70 and 80, between 80 and 90, between 90 and 100, between 100 and 110, between 110 and 120, between 120 and 140, between 140 and 160, between 160 and 180, between 180 and 200, between 180 and 250, between 250 and 300, between 300 and 350, between 350 and 400, between 50 and 400, between 100 and 400, between 400 and 600, between 600 and 1000, between 1000 and 2000, between 2000 and 5000 openings per square centimeter including any range or value therebetween.

In some embodiments, the water impermeable layer comprises at least 100, at least 200, at least 300, at least 400, at least 500, at least 1000, at least 2000, openings having a dimeter of less than 20 μm.

In some embodiments, a surface area of the openings is between 0.006 and 10%, between 0.06 and 0.01%, between 0.01 and 0.05%, between 0.05 and 0.1%, between 0.1 and 0.2%, between 0.2 and 0.3%, between 0.3 and 0.5%, between 0.5 and 1%, between 1 and 1.5%, between 1.5 and 2%, between 2 and 3%, between 3 and 5%, between 5 and 10% of the total surface area of the water impermeable layer including any range or value therebetween.

In some embodiments, the surface morphology of the water impermeable layer is predetermined by the manufacturing process. In some embodiments, the opening is located on top of the ridge. In some embodiments, the opening is characterized by a first diameter on the outer portion of the water impermeable layer and a second diameter on the inner portion of the water impermeable layer. In some embodiments, the outer portion is configured to face an ambient and an inner portion is configured to face crop material or an edible mater. In some embodiments, the first diameter is less than the second diameter. In some embodiments, a variation between the first diameter and the second diameter is at most 50%, at most 40%, at most 30%, a most 20%, at most 10%, at most 5%, at most 3%, including any value therebetween.

In some embodiments, the crater or the ridge is characterized by a height. In some embodiments, a surface roughness is predetermined by mean height value.

In some embodiments, the height of the plurality of ridges is in a range from 0.1 to 100 μm, from 1 to 10 μm, from 10 to 30 μm, from 30 to 50 μm, from 50 to 100 μm, including any range or value therebetween, wherein the ridges are related to the edges (e.g. perimeter) of the plurality of holes.

In some embodiments, the water impermeable layer comprises a polymer characterized by a melting temperature (Tm) between 50 and 300° C., between 50 and 55° C., between 55 and 60° C., between 60 and 70° C., between 70 and 80° C., between 80 and 90° C., between 90 and 100° C., between 100 and 110° C., between 110 and 120° C., between 120 and 130° C., between 130 and 150° C., between 150 and 200° C., between 200 and 220° C., between 220 and 250° C., between 250 and 270° C., between 270 and 300° C., including any range or value therebetween.

In some embodiments, the water impermeable layer of the composition comprises a thermoplastic polymer.

Non-limiting examples of thermoplastic polymers include but are not limited to: polyethylene, polypropylene, polyvinyl acetate, polyvinyl chloride, polyvinyl alcohol, polyamide, polyester including any mixture or a copolymer thereof.

Other non-limiting examples of thermoplastic polymers include but are not limited to: polybutadiene, polypropylene-ethylene copolymer, polyethylene, linear low density polyethylene (LLDPE), low density polyethylene (LDPE), medium density polyethylene (MDPE), high density polyethylene (HDPE), isotactic polypropylene, random polypropylene including any mixture or a copolymer thereof.

In some embodiments, the term “layer”, refers to a substantially homogeneous substance of substantially uniform-thickness. In some embodiments, the term “layer”, refers to a polymeric layer. In some embodiments, the water impermeable layer is in a form of a film.

In some embodiments, the thermoplastic polymer comprises a polyolefin. In some embodiments, polyolefin is polyethylene.

In some embodiments, the thermoplastic polymer further comprises an additive. In some embodiments, a weight per weight (w/w) ratio of the additive within the thermoplastic polymer is between 0.1 and 50%, between 0.1 and 0.5%, between 0.5 and 1%, between 1 and 10%, between 1 and 3%, between 3 and 5%, between 5 and 10%, between 10 and 20%, between 20 and 30%, between 30 and 40%, between 40 and 50%, including any range or value therebetween.

In some embodiments, the additive comprises any of: a plastomer, an elastomer, a pigment, a dye, an antioxidant (such as a radical scavenger, an antiozonant), a light stabilizer (such as a UV stabilizer), a heat stabilizer, a flame retardant and a biocide or any combination thereof.

Non-limiting examples of additives include but are not limited to 2,4-dihydroxybenzophenone, 2-hydroxy-4-N-(octyl) benzophenone, a derivative of 2-hydroxyphenyl-s-triazine, a hindered amine light stabilizer (HALS), benzotriazole-based UV absorber (such as Tinuvin), or a combination thereof.

In some embodiments, the water impermeable layer has a thickness between 10 and 200 μm, between 10 and 20 μm, between 20 and 40 μm, between 40 and 50 μm, between 50 and 60 μm, between 60 and 70 μm, between 70 and 80 μm, between 80 and 90 μm, between 90 and 100 μm including any range or value therebetween.

In some embodiments, the water impermeable layer is characterized by water vapor transmission rate (WVTR) of at least 300 gr/m²/day, at least 400 gr/m²/day, at least 350 gr/m²/day, at least 450 gr/m²/day, at least 500 gr/m²/day, at least 550 gr/m²/day, at least 600 gr/m²/day, at least 700 gr/m²/day, at least 800 gr/m²/day, at least 1000 gr/m²/day, at least 1500 gr/m²/day, at least 2000 gr/m²/day, at least 2500 gr/m²/day, including any value therebetween.

In some embodiments, the water impermeable layer is characterized by WVTR of at most 2000 gr/m²/day, at most 1500 gr/m²/day, at most 1000 gr/m²/day, at most 800 gr/m²/day, including any value therebetween.

In some embodiments, the water impermeable layer is stable at a temperature between −25 and 80° C., between −25 and 75° C., between −25 and 0° C., between 0 and 10° C., between 0 and 80° C., between 0 and 50° C., between 0 and 75° C., between 10 and 80° C., between 10 and 75° C., including any range or value therebetween.

In some embodiments, the water impermeable layer is stable upon exposure to UV and/or visible light radiation. In some embodiments, the water impermeable layer is stable for at least 12 months, for at least 15 months, for at least 18 months, for at least 20 months, at least 24 months upon exposure to UV radiation of 180 kilo Langley per year (KLy p.a.). In some embodiments, UV stability of the water impermeable layer is measured according to ISO 4892-2.

As used herein the term “stable” refers to the capability of the perforated layer (e.g. a water impermeable layer) to maintain its structural and/or mechanical integrity. In some embodiments, the perforated layer is referred to as stable, if the perforated layer is characterized by a mechanical integrity sufficient to be used as a packaging material. In some embodiments, the perforated layer is referred to as stable, if the perforated layer substantially maintains its structural and/or mechanical integrity under outdoor conditions such as a temperature −25 and 75° C., UV and/or visible light irradiation for a time period of at least 12 months, as described hereinabove. In some embodiments, the stable perforated layer is rigid under outdoor conditions. In some embodiments, the stable perforated layer maintains at least 50% of its tensile strength and/or elasticity. In some embodiments, substantially is as described hereinbelow.

In some embodiments, the water impermeable layer is characterized by elongation at break between 10 and 1000%, between 10 and 20%, between 20 and 30%, between 30 and 40%, between 40 and 50%, between 50 and 60%, between 50 and 100%, between 10 and 100%, between 60 and 100%, between 70 and 100%, between 80 and 100%, between 100 and 1000%, between 100 and 200%, between 200 and 300%, between 300 and 400%, between 400 and 500%, between 500 and 1000%, between 100 and 500%, between 500 and 700%, between 700 and 1000%, including any range or value therebetween.

In some embodiments, the water impermeable layer is characterized by tensile strength at a break between 5 and 50 N/10 mm, between 5 and 10 N/10 mm, between 10 and 50 N/10 mm, between 10 and 20 N/10 mm, between 20 and 30 N/10 mm, between 30 and 35 N/10 mm, between 35 and 40 N/10 mm, between 40 and 45 N/10 mm, between 45 and 50 N/10 mm, including any range or value therebetween.

In some embodiments, the water impermeable layer is in contact with a continuous layer. In some embodiments, a part of the water impermeable layer is in contact with a continuous layer. In some embodiments, at least 5%, at least 10%, at least 15%, at least 20%, at least 25%, at least 30%, at least 35%, at least 40%, at least 45%, at least 50%, of an area of the water impermeable layer is in contact with a continuous layer.

In some embodiments, at most 5%, at most 10%, at most 15%, at most 20%, at most 25%, at most 30%, at most 35%, at most 40%, at most 45%, at most 50%, of an area of the water impermeable layer is in contact with a continuous layer.

In some embodiments, at least a portion of the water impermeable layer is bound or adhered to a continuous layer. In some embodiments, the continuous layer is bound or adhered to an outer portion and/or to an inner portion of the water impermeable layer.

In some embodiments, the composition or the article of the invention comprises a plurality of layers. In some embodiments, the composition or the article of the invention comprises a first layer comprising the water impermeable layer of the invention and a second layer comprising the continuous layer disclosed herein, wherein the first layer and second layer are adhered or bound to each other.

In some embodiments, the water impermeable layer is stably attached to the continuous layer. In some embodiments, bound is by a physical interaction, by a non-covalent bond or both. In some embodiments, the water impermeable layer is welded to the continuous layer.

In some embodiments, the continuous layer is a polymeric layer. In some embodiments, the continuous layer comprises a polyolefin, wherein the polyolefin is as described herein. In some embodiments, the continuous layer is substantially devoid of openings, wherein substantially is as described hereinbelow. In some embodiments, the continuous layer is water impermeable.

In some embodiments, the continuous layer is in a form of strips or bands. In some embodiments, the continuous layer is in a form of a net. In some embodiments, the continuous layer is in a form of intertwined yarns, threads, fibers or strips. In some embodiments, the continuous layer is in a form of a net having longitudinal franze ribbons interconnected by schuss ribbons.

In some embodiments, the continuous layer increases a mechanical strength (such as tensile strength) of the water impermeable layer by at least 10%, by at least 20%, by at least 30%, by at least 50%, by at least 70%, by at least 100%, by at least 200%, by at least 300%, by at least 500%, by at least 700%, by at least 1000%, or any value therebetween.

In some embodiments, the continuous layer substantially maintains the shape of the wrapped crop material (e.g. a bale) or of a packaging article.

### Superhydrophobic Layer

According to another aspect, the perforated layer comprises a plurality of openings wherein at least 95% of openings within the perforated layer are of a diameter of less than 60 μm; wherein a contact angle of an outer surface of the perforated layer is more than 115°; and wherein a liquid permeability of the perforated layer is less than 0.6 gr when measured according to AATCC 35. In some embodiments, the outer surface of the perforated layer is a superhydrophobic layer. In some embodiments, the outer surface is as described herein. In some embodiments, the perforated layer is a continuous layer. In some embodiments, the perforated layer is a substantially homogenous layer. In some embodiments, the perforated layer is in a form of a film. In some embodiments, the perforated layer is a polymeric layer. In some embodiments, the perforated layer is a polymeric film. In some embodiments, the terms “perforated layer”, “perforated film” or “film” are used herein interchangeably.

In some embodiments, the perforated layer or film comprises one or more layers, such as polymeric layers. In some embodiments, the perforated layer or film comprises first bottom polymeric layer stably bound to second polymeric layer, wherein the outer surface of the second polymeric layer polymeric layer is superhydrophobic (e.g. characterized by a sliding angle and a contact angle as described hereinbelow), and the inner surface of the second polymeric layer is in contact with the first bottom polymeric layer. In some embodiments, the outer surface of the second polymeric layer is characterized by a surface morphology comprising a plurality of craters and heights, and further comprises hydrophobic nanoparticles bound thereto.

In some embodiments, the plurality of openings or perforations are located within the first bottom polymeric layer and within the second polymeric layer. In some embodiments, the first bottom polymeric layer and the second polymeric layer are perforated layers. In some embodiments, the locations (and/or pattern) of the plurality of openings within the first bottom polymeric layer and within the second polymeric layer are the same.

In some embodiments, there is a film comprising a plurality of openings, wherein at least 95% of openings within the film are of a diameter of less than 60 μm; wherein a contact angle of an outer surface of the film is more than 115°; and wherein a liquid permeability of the film is less than 0.6 gr when measured according to AATCC 35. In some embodiments, the film is a perforated film. In some embodiments, the film is a polymeric film. In some embodiments, the film is a perforated polymeric film.

In some embodiments, the superhydrophobic layer has a liquid permeability of less than 0.6 gr, less than 0.5 gr, less than 0.3 gr, less than 0.2 gr, less than 0.1 gr, less than 0.01 gr, including any range or value therebetween, wherein the liquid permeability is measured according to AATCC 35. In some embodiments, the liquid is a polar liquid comprising any of an alcohol (such as ethanol, methanol, and isopropanol), water, an aqueous solution or a combination thereof. In some embodiments, the liquid is water.

In some embodiments, the superhydrophobic layer (or perforated layer) is characterized by water permeability of less than 0.6 gr, when measured according to AATCC 35. In some embodiments, water permeability of the superhydrophobic layer is less than 0.5 gr, less than 0.3 gr, less than 0.2 gr, less than 0.1 gr, less than 0.01 gr, including any range or value therebetween. In some embodiments, the water permeability refers to an average value.

In some embodiments, the terms “superhydrophobic layer” and “perforated layer” are used herein interchangeably.

In some embodiments, the perforated layer is characterized by water vapor transmission rate (WVTR) of at least 300 gr/m²/day, at least 400 gr/m²/day, at least 350 gr/m²/day, at least 450 gr/m²/day, at least 500 gr/m²/day, at least 550 gr/m²/day, at least 600 gr/m²/day, at least 700 gr/m²/day, at least 800 gr/m²/day, at least 1000 gr/m²/day, at least 1500 gr/m²/day, at least 2000 gr/m²/day, at least 2500 gr/m²/day, including any value therebetween. In some embodiments, the WVTR value disclosed herein refers to an average value.

In some embodiments, the perforated layer is a polymeric layer. In some embodiments, the perforated layer is a single layer. In some embodiments, the perforated layer comprises a plurality of layers.

In some embodiments, the perforated layer has an outer surface and an inner surface. In some embodiments, an outer surface of the perforated layer is configured to face an ambient. In some embodiments, an outer surface of the perforated layer is referred to an exterior layer facing the ambient. In some embodiments, the outer surface of the perforated layer is referred to a superhydrophobic layer. In some embodiments the inner surface is configured to face a crop material (e.g. bale).

In some embodiments, the outer surface has a contact angle (CA) of more than 115°, more than 120°, more than 125°, more than 130°, more than 135°, more than 140°, more than 145°, more than 150°, including any range or value therebetween. In some embodiments, the CA value disclosed herein refers to an average value.

In some embodiments, the outer surface has a sliding angle (SA) of less than 35°, less than 30°, less than 25°, less than 20°, less than 15°, less than 12°, less than 10°, less than 8°, less than 5°, including any range or value therebetween.

In some embodiments, the outer surface has a sliding angle of less than 35° and a contact angle of more than 115°. In some embodiments, the SA value disclosed herein refers to an average value.

In some embodiments, the outer surface is water-repellant. In some embodiments, a water-repellant property of the outer surface is predetermined by a sliding angle of less than 35° and a contact angle of more than 115°. In some embodiments, the outer surface of the perforated layer defines the superhydrophobic layer. In some embodiments, the outer surface of the perforated layer is superhydrophobic.

In some embodiments the inner surface is substantially devoid of a surface morphology defining the outer surface. In some embodiments the inner surface is substantially devoid of any hydrophobic particle in contact therewith. In some embodiments, the inner surface is substantially devoid of water-repellant property. In some embodiments, the inner surface is substantially devoid of superhydrophobicity. In some embodiments the inner surface is characterized by substantially the same SA and/or CA as a pristine (e.g. substantially devoid of surface treatment and/or substantially devoid of any hydrophobic particle in contact therewith) thermoplastic polymer.

In some embodiments, the outer surface of the perforated layer is characterized by water-repellant regions. In some embodiments, at least 10%, at least 20%, at least 30%, at least 50%, at least 60%, at least 70%, at least 80%, at least 90%, at least 95% of the outer surface has water-repellant regions. It should be apparent to one skilled in the art, that the surface properties (such as the contact angle and the sliding angle) may vary throughout the surface area of the layer. In some embodiments, a value of the contact angle and/or of the sliding represent a mean value.

In some embodiments, at least 10%, at least 20%, at least 30%, at least 50%, at least 60%, at least 70%, at least 80%, at least 90%, at least 95% of the outer surface layer has a sliding angle of less than 35° and a contact angle of more than 115°.

Without being bound to any particular theory or mechanism, it is well recognized that the wetting of a solid with water, with air as the surrounding medium, depends on the relation between the interfacial tensions water/air, water/solid and solid/air. The ratio between these tensions determines the contact angle (CA) of a water droplet on a given surface and is described by Young's equation. If a droplet is applied to a solid surface, it will wet the surface to a certain degree. At equilibrium, the energy of the system is minimized, which can be described by the Young's Equation (Equation 1):

cos θ=(γSV−γSL)/γLV,

wherein γSL, γSV, and γLV are interfacial free energy per unit area of the solid-liquid (SL), solid-vapor (SV), and liquid-vapor (LV) interfaces, respectively and θ is the contact angle for a smooth surface.

Young's Equation can only be applied to a flat, smooth surface. On an inclined surface, the sliding angle (SA) of the outer surface has to be considered in order to provide water-repellant properties to the surface (i.e. to prevent adhesion or adsorption of water droplets on top of the surface). SA can be determined as described hereinbelow. SA can be calculated according to Equation 2:

mg sin α=σw(cos θᵣ−cos θₐ),

where σ is the surface tension of liquid, α is the SA, g is the gravitational acceleration, and m and w are the weight and the width of the contact circle of the liquid droplet, respectively.

In some embodiments, the values of SA and of CA are predetermined by a surface morphology. In some embodiments, the surface morphology is predetermined by the manufacturing process of the perforated layer (e.g. superhydrophobic layer).

In some embodiments, the outer surface of the perforated layer (e.g. the outer surface of the second polymeric layer) is characterized by a surface morphology comprising a plurality of craters. As used herein, the surface morphology refers to the outer superhydrophobic surface of the perforated layer (or film) of the invention, optionally the perforated layer (or film) of the invention comprises a plurality of layer than the outer surface is the outer surface of the second polymeric layer. One skilled in the art will appreciate, that the craters can have any geometrical shape and/or dimension. The craters may have the same shape or at least a portion of the plurality of craters may have a different shape.

In some embodiments, the craters are spherically shaped. In some embodiments, the craters are elliptically shaped. In some embodiments, the craters are extended along the stretching direction. In some embodiments, the craters are conically shaped. In some embodiments, any one of the craters is randomly shaped. In some embodiments, the inner surface is substantially devoid of craters. In some embodiments, the plurality of craters forms a pattern on top of the outer surface of the perforated layer. In some embodiments, the pattern is any pattern, such as a rectangular, elliptical, round, or horseshoe including any combination thereof. In some embodiments, the plurality of craters is randomly distributed within the outer surface of the perforated layer.

In some embodiments, the craters cover between 20 and 80%, between 20 and 40%, between 40 and 80%, between 50 and 80%, between 60 and 90%, between 50 and 80%, between 20 and 90%, between 20 and 95%, of the outer surface of the perforated layer, including any range between.

In some embodiments, a ratio of the total surface are of the craters (located on the outer surface) to the total surface area of the outer surface of the perforated layer is between 10 and 80%, between 10 and 30%, between 10 and 90%, between 50 and 90%, between 30 and 90%, between 30 and 95%, between 20 and 40%, between 40 and 80%, between 50 and 80%, between 60 and 90%, between 50 and 80%, between 80 and 95%, including any range between.

In some embodiments, the perforated layer comprises a plurality of layers. In some embodiments, the perforated layer comprises a first bottom polymeric layer, wherein the first bottom polymeric layer is substantially devoid of inner cavities or craters. In some embodiments, the outer surface of the second polymeric layer is characterized by a foam-like structure (or porosity), and by a surface morphology comprising a plurality of craters and peaks, as described herein. In some embodiments, the first bottom polymeric layer is substantially devoid of a foam-like structure. In some embodiments, the perforated layer comprises a second polymeric layer on top of the first bottom polymeric layer. In some embodiments, the second polymeric layer comprises a plurality of layers.

In some embodiments, dimensions (such as diameter and height) and/or density of the plurality of peaks and/or craters are predetermined by the manufacturing process. In some embodiments, the plurality of peaks and craters is formed by introduction of a blowing agent (including inter alia an endothermic or exothermic chemical foaming agent) to the thermoplastic polymer. Such blowing agents are capable of releasing gas bubbles so as to induce a foam-like structure of the polymeric layer, thus resulting in the crater formation on the outer surface. In some embodiments, a blowing agent is an endothermic chemical foaming agent which usually decomposes at temperatures in the range of 160-220 C and yields around 100-200 ml gas per gr of the agent. Various blowing endothermic chemical foaming agent are well-known in the art, such as dicarbon amide, or carbonate and/or bicarbonate salts. Additional processes for obtaining the surface morphology disclosed herein are well-known in the art and include for example controlled laser ablation, chemical etching, coating etc.

Without being bound to any particular theory, it is postulated that the surface morphology of the perforated layer (e.g. the outer surface of the second polymeric layer) is important for binding or adherence of the coating (e.g. the hydrophobic particles described herein) to the perforated layer. Specifically, it is postulated that particular surface roughness (including Rz, Ra, and/or Rq, as disclosed herein) of the perforated layer is beneficial for bonding or adherence of the coating thereto, thereby forming a stable coating and thereby predetermining superhydrophobic properties and water impermeability of the perforated layer.

In some embodiments, the perforated layer is a porous layer. In some embodiments, the term “porous layer” and “foam-like structure” are used herein interchangeably. In some embodiments, the perforated layer (or the second polymeric layer) is characterized by a porosity between 1 and 60%, between 1 and 10%, between 10 and 20%, between 20 and 30%, between 30 and 60%, between 60 and 80%, between 30 and 80%, between 20 and 80%, between 20 and 50%, between 10 and 60%, including any value or range therebetween. In some embodiments, the perforated layer has a pore size between 10 and 5000 μm, between 10 and 100 μm, between 100 and 500 μm, between 500 and 1000 μm, between 1000 and 2000 μm, between 2000 and 5000 μm, between 3000 and 5000 μm, between 100 and 2000 μm, between 100 and 2500 μm, between 100 and 3000 μm, including any value therebetween. In some embodiments, the pore size value disclosed herein refers to an average value.

In some embodiments, the plurality of craters is characterized by any geometric form or shape. In some embodiments, the plurality of craters has substantially round shape or substantially elliptical shape. In some embodiments, the plurality of craters has an irregular shape. In some embodiments, the plurality of openings has a random shape.

In some embodiments, the rim diameter (or cross-section) is between 10 and 2000 μm, between 30 and 50 μm, between 50 and 70 μm, between 70 and 100 μm, between 100 and 120 μm, between 100 and 300 μm, between 100 and 150 μm, between 150 and 200 μm, between 200 and 250 μm, between 250 and 300 μm, between 300 and 400 μm, between 400 and 500 μm, between 500 and 1000 μm, between 1000 and 2000 μm, between 2000 and 5000 μm, between 3000 and 5000 μm, between 100 and 2000 μm, between 100 and 2500 μm, between 100 and 3000 μm, including any value therebetween, wherein the rim diameter defines the diameter of the opening on top of the crater. In some embodiments, the rim diameter (or cross-section) value disclosed herein refers to an average value. As used herein, the term “rim diameter” is referred to an average diameter or cross-section measured at the top edge of the crater.

In some embodiments, at least 70%, at least 80%, at least 90%, at least 95% of the plurality of craters are elliptically shaped, including any range between. In some embodiments, an average width dimension of the plurality of craters (e.g. elliptical carters) is between 10 and 2000 μm, between 10 and 100 μm, between 100 and 120 μm, between 100 and 300 μm, between 100 and 150 μm, between 150 and 200 μm, between 200 and 250 μm, between 250 and 300 μm, between 300 and 400 μm, between 400 and 500 μm, between 100 and 500 μm, between 500 and 1000 μm, between 1000 and 2000 μm, between 2000 and 5000 μm, between 3000 and 5000 μm, between 100 and 2000 μm, between 100 and 2500 μm, between 100 and 3000 μm, including any value therebetween.

In some embodiments, an average length dimension of the plurality of craters (e.g. elliptical carters) is between 10 and 4000 μm, between 10 and 100 μm, between 100 and 120 μm, between 100 and 300 μm, between 100 and 150 μm, between 150 and 200 μm, between 200 and 250 μm, between 250 and 300 μm, between 300 and 400 μm, between 400 and 500 μm, between 100 and 500 μm, between 500 and 1000 μm, between 1000 and 2000 μm, between 2000 and 5000 μm, between 3000 and 5000 μm, between 100 and 2000 μm, between 100 and 2500 μm, between 100 and 3000 μm, between 100 and 4000 μm, between 100 and 3500 μm, including any value therebetween.

In some embodiments, the crater is characterized by a depth. In some embodiments, a surface roughness is predetermined by mean or average depth value of the craters and/or by a mean or average height of the peaks. In some embodiments, a surface roughness is predetermined by standard deviation of the depth values of the craters and/or by standard deviation of height values of the peaks, wherein the standard deviation is referred to a deviation from a virtual baseline. Various surface roughness parameters are known in the art including inter alia Rz, Ra, and/or Rq, as disclosed herein.

In some embodiments, the average depth of the plurality of craters is in a range from 1 to 500 μm, from 10 nm to 1 μm, from 100 nm to 1 μm, from 10 to 30 μm, from 10 to 20 μm, from 20 to 50 μm, from 50 to 100 μm, from 100 to 200 μm, from 200 to 500 μm, including any range or value therebetween. In some embodiments, the average depth of the plurality of craters is in a range from 10 to 100 μm, from 10 to 50 μm, from 10 to 80 μm, from 10 to 40 μm, from 10 to 60 μm, from 10 to 30 μm, from 5 to 50 μm, from 5 to 20 μm, from 5 to 10 μm, from 5 to 70 μm, from 10 to 30 μm, from 10 to 20 μm, from 20 to 50 μm, from 50 to 100 μm, from 100 to 200 μm, including any range or value therebetween.

In some embodiments, the average height of the plurality of peaks is in a range from 10 to 500 μm, from 10 to 100 μm, from 10 to 50 μm, from 10 to 20 μm, from 10 to 150 μm, from 10 to 70 μm, from 10 to 30 μm, from 10 to 20 μm, from 20 to 50 μm, from 50 to 100 μm, from 100 to 200 μm, from 200 to 300 μm, from 300 to 500 μm, including any range or value therebetween.

In some embodiments, the outer surface of the perforated layer of the invention has a plurality of carters and peaks, wherein the average depth of the plurality of craters is in a range from 10 to 100 μm, from 10 to 50 μm, or at least 5 μm, or at least 7 μm, or at least 10 μm; and wherein the average height of the plurality of peaks is from 10 to 100 μm, from 10 to 50 μm at least 5 μm, or at least 7 μm, or at least 10 μm, or at least 10 μm including any range between. In some embodiments, the outer surface of the perforated layer of the invention has a plurality of carters and peaks, wherein the average depth of the plurality of craters is in a range from 10 to 100 μm, from 10 to 50 μm, or at least 5 μm, or at least 7 μm, or at least 10 μm; and wherein the average height of the plurality of peaks is from 10 to 100 μm, from 10 to 50 μm at least 5 μm, or at least 7 μm, or at least 10 μm, or at least 10 μm including any range between, and wherein the surface roughness parameters (Rz, Ra, and/or Rq) are as disclosed herein.

In some embodiments, Rz of the outer (superhydrophobic) surface of the perforated layer (or film) of the invention is between 50 and 300, between 50 and 200, between 50 and 55, between 50 and 60, between 55 and 300, between 55 and 200, between 50 and 500, between 50 and 400, between 200 and 300, between 50 and 500, between 150 and 300, between 150 and 400, between 150 and 500, including any range or value between. In some embodiments, Rz of the outer (superhydrophobic) surface of the perforated layer (or film) of the invention is at least about 49, at least about 50, at least about 52, at least about 55, at least about 60, at least about 70, at least about 80, at least about 100, including any range or value between.

In some embodiments, the outer (superhydrophobic) surface of the perforated layer (or film) of the invention is substantially devoid (at most 30%, at most 20%, at most 10%, at most 5%, at most 1% of the surface area) of a surface area characterized by Rz of less than 55, less than 53, less than 51, less than 50, less than 49, less than 48, including any range or value between.

As used herein Rz is referred to a Maximum height, which represents the sum of the maximum peak height Zp and the maximum valley depth Zv of a profile within the reference length. Profile peak refers to a portion above (from the object) the mean profile line (X-axis); and profile valley refers to a portion below (from the surrounding space) the mean profile line (X-axis).

In some embodiments, Ra of the outer (superhydrophobic) surface of the perforated layer (or film) of the invention is between 5 and 100, between 5 and 40, between 7 and 50, between 7 and 100, between 7 and 10, between 10 and 20, between 20 and 50, between 20 and 40, between 40 and 80, between 50 and 100, including any range or value between. In some embodiments, Ra of the outer (superhydrophobic) surface of the perforated layer (or film) of the invention is at least about 5, at least about 6, at least about 7, at least about 8, at least about 10, at least about 20, at least about 30, including any range or value between.

In some embodiments, the outer (superhydrophobic) surface of the perforated layer (or film) of the invention is substantially devoid (at most 30%, at most 20%, at most 10%, at most 5%, at most 1% of the surface area) of a surface area characterized by Ra of less than 8, less than 6, less than 7, less than 10, including any range or value between.

As used herein Ra is referred to Arithmetic mean deviation, which represents the arithmetric mean of the absolute ordinate Z(x) within the sampling length.

In some embodiments, Rq of the outer (superhydrophobic) surface of the perforated layer (or film) of the invention is between 5 and 100, between 5 and 40, between 8 and 50, between 8 and 100, between 8 and 70, between 8 and 10, between 10 and 20, between 20 and 50, between 20 and 40, between 40 and 80, between 10 and 50, between 10 and 60, between 40 and 60, between 60 and 80, between 80 and 100, between 50 and 100, including any range or value between. In some embodiments, Rq of the outer (superhydrophobic) surface of the perforated layer (or film) of the invention is at least about 5, at least about 6, at least about 7, at least about 8, at least about 10, at least about 20, at least about 30, including any range or value between.

In some embodiments, the outer (superhydrophobic) surface of the perforated layer (or film) of the invention is substantially devoid (at most 30%, at most 20%, at most 10%, at most 5%, at most 1% of the surface area) of a surface area characterized by Rq of less than 8, less than 6, less than 7, less than 10, including any range or value between.

As used herein Rq is referred to Root mean square deviation (Rq), which represents the root mean square for Z(x) within the sampling length.

In some embodiments, the outer (superhydrophobic) surface is characterized by a plurality of ridges and valleys formed by the plurality of openings. In some embodiments, the opening is located on top of the ridge. In some embodiments, each of the ridges are formed by a pair of vertically oriented convergent and/or conical side walls.

In some embodiments, the entire width dimension of the perforated layer or film of the invention is perforated. In some embodiments, each of the openings (or at least 80%, at least 90%, at least 95% of the plurality of opening) traverses or propagates across the entire width dimension of the perforated layer or film of the invention. In some embodiments, the width dimension is defined by the distance between the outer surface and the inner surface of the perforated layer. In some embodiments, the outer surface (or superhydrophobic) and the inner surface are opposing surfaces.

In some embodiments, the plurality of openings is in a form of ridges at the outer surface of the perforated layer. In some embodiments, each ridge has a rim expanding from the outer (or superhydrophobic) surface, and a floor (or bottom) at the inner surface of the perforated layer. In some embodiments, each opening or perforation has an opening at the floor (or bottom portion) and at the rim of the ridge. In some embodiments, each opening traverses or propagates across the entire height dimension of the ridge.

In some embodiments, the plurality of ridges and valleys form a pattern on top of the outer surface. In some embodiments, the plurality of ridges and valleys form a plurality of rows. In some embodiments, the plurality of ridges and valleys is randomly oriented. In some embodiments, the plurality of ridges and valleys are defined by the plurality of openings as described hereinbelow. In some embodiments, the ridge is in a form of a cone having a floor (or bottom) diameter greater than a rim (or top) diameter. In some embodiments, the shape of the ridge is predetermined by the perforation process. In some embodiments, the shape of the ridge is predetermined by the shape of the opening.

In some embodiments, dimensions (such as diameter and height) of the plurality of ridges are predetermined by a perforation process.

In some embodiments, the average floor diameter (or cross-section) is between 30 and 120 μm, between 30 and 50 μm, between 50 and 70 μm, between 70 and 100 μm, between 100 and 120 μm, including any value therebetween, wherein the floor diameter defines the diameter of the opening at the basis of the crater, as described hereinbelow.

In some embodiments, the ridge is characterized by a height. In some embodiments, a surface roughness is predetermined by mean height value. As used herein, the term “floor diameter” is referred to an average diameter (or cross-section) measured at a basis of the crater. As used herein, the term “rim diameter” is referred to an average diameter (or cross-section) at a top of the crater. In some embodiments, the rim diameter is identical with the diameter of the plurality of openings, as described hereinabove.

In some embodiments, the average height of the plurality of ridges is in a range from 10 nm to 100 μm, from 10 nm to from 100 nm to from 10 nm to 30 μm, from 10 nm to 20 μm, from 20 nm to 50 μm, from 50 nm to 100 μm including any range or value therebetween, wherein the plurality of craters or ridges is defined by the edges of the plurality of openings.

In some embodiments, the values of SA and of CA are predetermined by the surface roughness (e.g. peak height and/or depth of the craters, and optionally by any of Ra, Rq, and Rz). In some embodiments, the outer surface of the superhydrophobic layer is characterized by a surface roughness of between 1 nm and 20 μm.

In some embodiments, the surface roughness of the superhydrophobic layer is between 1 and 1000 nm, between 1 and 10 nm, between 10 and 1000 nm, between 10 nm and 10 μm, between 10 nm and 5 μm, between 10 nm and 2 μm, between 2 and 5 μm, between 10 nm and 1 μm, between 100 nm and 10 μm, between 100 nm and 5 μm, between 100 nm and 2 μm, between 100 nm and 1 μm, between 200 nm and 10 μm, between 200 nm and 5 μm, between 200 nm and 1 μm, between 10 nm and 10 μm μm between 100 nm and 1000 nm, between 10 and 100 nm, between 10 and 20 nm, between 10 and 50 nm, between 20 and 50 nm, between 50 and 100 nm, between 10 and 200 nm, between 100 and 200 nm, between 200 and 300 nm, between 300 and 400 nm, between 400 and 500 nm, between 500 and 600 nm, between 600 and 700 nm, between 700 and 800 nm, between 800 and 1000 nm, including any range or value therebetween.

In some embodiments, at least 85%, at least 90%, at least 92%, at least 95%, at least 96%, at least 97%, at least 98%, at least 99% of openings have an average diameter (or cross-section) of less than 60 μm, less than 55 μm, less than 50 μm, less than 45 μm, less than 40 μm, less than 35 μm, less than 32 μm including any range or value therebetween.

In some embodiments, the plurality of openings have an average diameter between 10 and 60 μm, between 10 and 50 μm, between 10 and 55 μm, between 10 and 45 μm, between 10 and 40 μm, between 10 and 35 μm, between 10 and 30 μm, between 20 and 60 μm, between 20 and 50 μm, between 20 and 55 μm, between 20 and 40 μm, between 10 and 20 μm, between 10 and 15 μm, between 15 and 20 μm, between 20 and 25 μm, between 25 and 30 μm, between 20 and 30 μm, between 30 and 60 μm, between 25 and 60 μm, between 25 and 30 μm, between 25 and 50 μm, between 25 and 40 μm, between 35 and 60 μm, including any range or value therebetween.

In some embodiments, the perforated layer is substantially devoid of openings having a diameter of less than 20 μm. In some embodiments, a percentage of openings within the superhydrophobic layer having a diameter of less than 20 μm is less than 10%, less than 8%, less than 5%, less than 3%, less than 2%, less than 1%, less than 0.5%, less than 0.1%, less than 0.01%, including any range or value therebetween.

In some embodiments, a value of the diameter is a mean or average value. In some embodiments, a standard deviation of the diameter value is between 1 and 20 μm, between 1 and 5 μm, between 5 and 10 μm, between 10 and 15 μm, between 15 and 20 μm, including any range or value therebetween.

In some embodiments, the perforated layer is substantially devoid of openings having a diameter greater than 60 μm, greater than 65 μm, greater than 70 μm, greater than 80 μm, including any range or value therebetween. In some embodiments, a percentage of openings having a diameter greater than 60 μm within the superhydrophobic layer is less than 5%, less than 4%, less than 3%, less than 2%, less than 1%, less than 0.5%, less than 0.1%, less than 0.01%, less than 0.05%, including any range or value therebetween.

In some embodiments, liquid permeability of the superhydrophobic layer is predetermined by a diameter of the opening and by values of SA and of CA. In some embodiments, the superhydrophobic layer having a mean or average opening diameter (or cross-section) between 25 and 30 μm, between 25 and 35 μm, between 25 and 40 μm, between 40 and 50 μm, between 50 and 60 μm is characterized by SA of less than 30° and by CA of greater than 110°. In some embodiments, the superhydrophobic layer having a mean or average opening diameter (or cross-section) between 40 and 60 μm, between 45 and 60 μm, between 50 and 60 μm is characterized by SA of less than 10° and by CA of greater than 145°.

In some embodiments, the plurality of openings is characterized by any geometric form or shape. In some embodiments, the plurality of openings has substantially round shape or substantially elliptical shape. In some embodiments, the plurality of openings has an irregular shape. In some embodiments, the plurality of openings has a random shape.

In some embodiments, at least a part of the plurality of openings is characterized by a linear shape. In some embodiments, at least a part of the plurality of openings has a slot geometry. In some embodiments, the plurality of openings has an elongated shape (e.g. a linear shape) having a width of less than 70 μm, less than 60 μm, less than 50 μm, less than 40 μm, less than 35 μm, less than 30 μm, less than 20 μm, less than 10 μm, less than 5 μm, including any range or value therebetween.

In some embodiments, the plurality of openings being characterized by a linear shape has an average length of 30 to 1000 μm, 20 to 30 μm, 30 to 50 μm, 50 to 70 μm, 70 to 100 μm, 100 to 200 μm, 200 to 300 μm, 300 to 400 μm, 400 to 500 μm, 500 to 600 μm, 600 to 800 μm, 800 to 1000 μm, including any range or value therebetween.

In some embodiments, at least 85%, at least 90%, at least 92%, at least 95%, at least 96%, at least 97%, at least 98%, at least 99% of openings have substantially round shape or substantially elliptical shape. In some embodiments, substantially round-shaped holes are characterized by a shape factor (SF) of 1 to 100. In some embodiments, the plurality of openings has a coefficient of variation of SF between 10 and 100%.

The openings are for the most part irregular in shape, that is, they do not assume a clearly identifiable geometric configuration such as circular, square or oval.

As used herein, the term “shape” is referred to a contour of a hole.

Shape Factor is an indication of the roundness of a hole or opening in a material being tested. Shape Factor (SF) is defined by the formula: P²KA where P is the perimeter of the hole or opening being measured, A is the area of the hole or opening and K is a constant. For a hole or opening which is perfectly circular in configuration, the Shape Factor, SF, is unity, i.e. 1. The higher the value of the Shape Factor, the more irregular, i.e. the less circular, is the configuration of the hole or opening.

In some embodiments, the openings and are randomly distributed within the perforated layer. In some embodiments, the openings form a specific pattern within the superhydrophobic layer. In some embodiments, the openings are provided in a pattern of distinct groups within the perforated layer. In some embodiments, the pattern of distinct groups or clusters of openings may be either random or regular; in either instance the openings in each distinct group or cluster may be randomly distributed therein.

In some embodiments, the openings in a specific pattern are arranged in rows running crosswise of the polymeric layer and in columns running lengthwise of the polymeric layer.

An “elliptical shape” as used herein, is characterized by a minor axis and a major axis. In some embodiments, the diameter of an elliptically shaped opening is referred to a minor axis.

As used herein, the term “opening” relates to a hole, perforation or an aperture.

In some embodiments, the perforated layer comprises at least 10, at least 20, at least 30, at least 40, at least 50, at least 60, at least 70, at least 80, at least 90, at least 95, at least 100, at least 105, at least 110, at least 115, at least 120, at least 130, at least 135, at least 140, at least 145, at least 150, at least 155, at least 160, at least 165, at least 170, at least 175, at least 180, at least 190, at least 200, at least 210, at least 220, at least 230, at least 240, at least 250, at least 260, at least 270, at least 280, at least 290, at least 300, at least 310, at least 320, at least 330, at least 340, at least 350, at least 370, at least 390, at least 400, at least 500, at least 600, at least 700, at least 800, at least 1000, at least 2000 openings per square centimeter including any value therebetween. In some embodiments, the superhydrophobic layer comprises at least 30 openings per square centimeter.

In some embodiments, the perforated layer comprises between 30 and 200, between 50 and 60, between 60 and 70, between 70 and 80, between 80 and 90, between 90 and 100, between 100 and 110, between 110 and 120, between 120 and 140, between 140 and 160, between 160 and 180, between 180 and 200, between 180 and 250, between 250 and 300, between 300 and 350, between 350 and 400, between 50 and 400, between 500 and 600, between 600 and 1000, between 1000 and 2000, between 2000 and 5000 openings per square centimeter including any range or value therebetween.

In some embodiments, the perforated layer comprises between 30 and 200, between 200 and 400, between 400 and 1000, between 1000 and 2000 openings per square centimeter, wherein a diameter of the openings is less than 60 μm. In some embodiments, the perforated layer comprises at most 500 openings per square centimeter, wherein a diameter of the openings is less than 60 μm.

In some embodiments, a surface area of the openings is between 0.006 and 10%, between 0.06 and 0.01%, between 0.01 and 0.05%, between 0.05 and 0.1%, between 0.1 and 0.2%, between 0.2 and 0.3%, between 0.3 and 0.5%, between 0.5 and 1%, between 1 and 1.5%, between 1.5 and 2%, between 2 and 3%, between 3 and 5%, between 5 and 10% of the total surface area of the superhydrophobic layer including any range or value therebetween.

In some embodiments, the perforated layer of the invention is a polymeric layer. In some embodiments, the perforated layer of the invention is in a form of a film.

In some embodiments, the perforated layer comprises a polymer (e.g. a thermoplastic polymer) characterized by a melting temperature (Tm) between 50 and 300° C., between 50 and 55° C., between 55 and 60° C., between 60 and 70° C., between 70 and 80° C., between 80 and 90° C., between 90 and 100° C., between 100 and 110° C., between 110 and 120° C., between 120 and 130° C., between 130 and 150° C., between 150 and 200° C., between 200 and 220° C., between 220 and 250° C., between 250 and 270° C., between 270 and 300° C., including any range or value therebetween.

In some embodiments, the perforated layer of the composition comprises a thermoplastic polymer.

Non-limiting examples of thermoplastic polymers include but are not limited to: a polyolefine, polypropylene, polyvinyl acetate, polyvinyl chloride, polyvinyl alcohol including any mixture or a copolymer thereof.

Other non-limiting examples of polyolefines include but are not limited to: polybutadiene, polypropylene-ethylene copolymer, linear low density polyethylene (LLDPE), low density polyethylene (LDPE), medium density polyethylene (MDPE), high density polyethylene (HDPE), isotactic polypropylene, random polypropylene, a polyethylene, a polypropylene, polymethylpentene (PMP), polybutene-1 (PB-1); ethylene-octene copolymer, stereo-block polypropylene, propylene-butane copolymer, including any mixture or a copolymer thereof.

In some embodiments, the term “layer”, refers to a substantially homogeneous substance of substantially uniform-thickness. In some embodiments, the term “layer”, refers to a polymeric layer. In some embodiments, the superhydrophobic layer is in a form of a film.

In some embodiments, the thermoplastic polymer comprises a polyolefin. In some embodiments, polyolefin is polyethylene.

In some embodiments, the thermoplastic polymer further comprises an additive. In some embodiments, a weight per weight (w/w) ratio of the additive within the thermoplastic polymer is between 0.1 and 30%, between 0.1 and 0.5%, between 0.5 and 1%, between 1 and 10, between 10 and 20%, between 20 and 30%, between 1 and 3%, between 3 and 5%, between 5 and 10%, including any range or value therebetween.

In some embodiments, the additive comprises any of: a plastomer, an elastomer, a pigment, a dye, an antioxidant (such as a radical scavenger, an antiozonant), a light stabilizer (such as a UV stabilizer), a heat stabilizer, a flame retardant and a biocide or any combination thereof.

Non-limiting examples of additives include but are not limited to 2,4-dihydroxybenzophenone, 2-hydroxy-4-N-(octyl) benzophenone, a derivative of 2-hydroxyphenyl-s-triazine, a hindered amine light stabilizer (HALS), benzotriazole-based UV absorber (such as Tinuvin) or a combination thereof.

In some embodiments, the outer surface of the perforated layer comprises a coating. In some embodiments, the outer surface and the inner surface of the perforated layer comprises a coating. In some embodiments, the superhydrophobic layer further comprises a coating. In some embodiments, the outer surface is in contact with a coating. In some embodiments, the outer surface is bound to a coating. In some embodiments, bound is via a physical interaction, a non-covalent bond or both. In some embodiments, the coating is adhered to the outer surface. In some embodiments, the coating is embedded within the outer surface. In some embodiments, the coating is positioned (i) within the craters, (ii) on top of the ridges (optionally partially covering the opening), (iii) on the side walls or any combination thereof (i to iii).

In some embodiments, the coating comprises a particle. In some embodiments, the coating comprises an inorganic particle (e.g. metal oxide particle). In some embodiments, the particle is selected from the group consisting of: silica, alumina, zeolites, an organic particle (e.g., carbon nano-particle including inter alia nano-tubes, nano-fibers, carbon black), a hybrid organic-inorganic particle (e.g., particles based on a mixture of silica/titania/alumina with an organic polymer) or any combination thereof.

In some embodiments, the outer surface of the perforated layer comprises a hydrophobic coating. In some embodiments, the superhydrophobic layer further comprises a hydrophobic coating. In some embodiments, the outer surface is in contact with a hydrophobic coating. In some embodiments, the outer surface is bound to a hydrophobic coating. In some embodiments, bound is via a physical interaction, a non-covalent bond or both. In some embodiments, the hydrophobic coating is adhered to the outer surface. In some embodiments, the hydrophobic coating is embedded within the outer surface. In some embodiments, the hydrophobic coating is positioned within the craters, on top of the ridges, on the side walls or any combination thereof.

In some embodiments, the hydrophobic coating forms a hydrophobic layer above the opening. In some embodiments, the hydrophobic coating forms a hydrophobic region on or within the opening. In some embodiments, the hydrophobic coating forms an entangled network on top of the opening. In some embodiments, the hydrophobic coating reduces a diameter of the opening.

In some embodiments, the hydrophobic coating or coating on top of the perforated layer is in a form of a layer. In some embodiments, the coating is in a form of hydrophobic regions. In some embodiments, the coating is in a form of an entangled network.

In some embodiments, the hydrophobic coating comprises a plurality of hydrophobic particles (e.g. chemically distinct particles). In some embodiments, the hydrophobic particle is selected from the group consisting of: a hydrophobic silica, a hydrophobic alumina, a hydrophobic inorganic particle (e.g., carbon nano-particles including inter alia nano-tubes, nano-fibers, carbon black and zeolites), a hybrid organic-inorganic particle (e.g., particles based on a mixture of silica/titania/alumina with a hydrophobic polymer) or any combination thereof.

In some embodiments, the hydrophobic coating comprises between 0.01 and 10%, between 0.1 and 10%, between 0.1 and 0.5%, between 0.5 and 1%, between 1 and 10, between 1 and 5%, between 1 and 3%, between 3 and 5%, between 5 and 10% w/w of an additive, including any range or value therebetween. In some embodiments, the additive comprises any of: a tackifier, a filler (e.g. a clay particle), an elastomer, a pigment, a dye, an antioxidant (such as a radical scavenger, an antiozonant), a light stabilizer (such as a UV stabilizer), a heat stabilizer, a flame retardant and a biocide or any combination thereof.

In some embodiments, the hydrophobic coating consists essentially of the hydrophobic particles, and optionally of the additive, as describe herein. In some embodiments, at least 80%, at least 90%, at least 92%, at least 95%, at least 97%, at least 99%, at least 99.9%, at least 99.99% by dry weight of the hydrophobic coating is composed of the hydrophobic particles. In some embodiments, at least 80%, at least 90%, at least 92%, at least 95%, at least 97%, at least 99%, at least 99.9%, at least 99.99% by dry weight of the hydrophobic coating is composed of the hydrophobic particles and of the additive.

In some embodiments, the hydrophobic coating is substantially devoid of a surfactant.

In some embodiments, the hydrophobic particle comprises a particle (such as an inorganic particle comprising any of nano clay, SiO₂, TiO₂, Al2O₃, ZnO, and/or ZrO) in contact with a hydrophobic material. In some embodiments, the inorganic particle is bound to hydrophobic material, wherein bound comprises a covalent bond or a non-covalent bond.

Herein throughout, the term “nano clay” refers to particles of a clay material, useful for making nanocomposites, which particles can comprise layers or platelet particles (platelets) obtained from particles comprising layers and, depending on the stage of production, can be in a stacked, intercalated, or exfoliated state.

In some embodiments, the nano clay comprise montmorillonite.

In some embodiments, the nano clay comprises chemically modified nano clay, that is, nano clays as described herein which have been treated so as to modify the surface thereof by inclusion of organic moieties (e.g., treated with hydrophobic material, as described herein).

In some embodiments, the hydrophobic material is bound to a surface of the inorganic particle. In some embodiments, the hydrophobic particle comprises the inorganic particle coated by a hydrophobic material.

In some embodiments, the hydrophobic material comprises a polymer (such as a vinyl-based polymer, a polyolefin, styrene-based polymer, polyacrylate, polymetacrylate, polysiloxane, polysilane, polysilazane, polyvinyl alcohol (PVA), poly (2ethyl-2-oxazoline), carboxymethyl cellulose (CMC) including a copolymer or a combination thereof); a fatty acid (such as stearic acid).

In some embodiments, the hydrophobic particle comprises a substituent covalently bound to an oxygen atom. In some embodiments, the substituent is bound to a heteroatom on a surface of the particle. In some embodiments, the substituent is bound to any of hydroxy group, amino group, thiol group or a combination thereof.

In some embodiments, the substituent is hydrophobic. In some embodiments, the substituent is devoid of polar groups. In some embodiments, the substituent comprises any of alkyl, phenyl, vinyl, fluoroalkyl, haloalkyl, halogen, epoxy, a heterocyclic ring, a saturated ring, an alkene, a haloalkene, an alkyne, an ether, a silyl group, a siloxane group, a thioether or any combination thereof.

In some embodiments, the substituent is an alkyl. In some embodiments, the alkyl is a linear or a branched alkyl. In some embodiments, the linear alkyl comprises between 1 and 20, between 1 and 15, between 1 and 10, between 1 and 5, between 5 and 10, between 10 and 15, between 15 and 20, including any range or value therebetween.

In some embodiments, the hydrophobic particle is a hydrophobic silica particle. In some embodiments, the hydrophobic silica comprises chemically modified silica. In some embodiments, a chemical modification comprises any of alkylation, fluorination, silylation, trifluoromethylation, amidation or any combination thereof. Other examples of hydrophobic silica are well-known in the art.

In some embodiments, the hydrophobic silica particle comprises a substituent masking at least a part of the hydroxy groups on the particle's surface. In some embodiments, the substituent increases surface hydrophobicity of the silica particle. In some embodiments, the hydrophobic silica particle comprises an alkylated silica. In some embodiments, the hydrophobic silica particle comprises an alkyl silylated silica. In some embodiments, the hydrophobic silica particle comprises alkyl-functionalized, silane-functionalized, alkoxy silane-functionalized, alkyl silane-functionalized metal oxide nanoparticle (e.g. silica), or any combination thereof. In some embodiments, functionalized comprises a chemical moiety covalently bound to the metal oxide nanoparticle. In some embodiments, the chemical moiety comprises any of (C1-C20) alkyl, (C1-C20) alkylsilane group also used herein as (C1-C20) alkylsilyl group, a halosilyl group, vinyl, epoxy, a cycloalkane, an alkene, an alkyne, an ether, a silyl group, and a siloxane group, or any combination thereof.

In some embodiments, the alkylated silica comprises a C1-C10 alkyl covalently attached thereto. In some embodiments, the alkylated silica comprises a C1-C5 alkyl covalently attached thereto. In some embodiments, the alkylated silica comprises methylated silica (C1-silica).

In some embodiments, the hydrophobic silica particle comprises an (C1-C20) alkylsilane group bound thereto. In some embodiments, the (C1-C20) alkylsilane group comprises a Si bound to at least one C1-C20 alkyl, wherein C1-C20 alkyl comprises between 1 and 20, between 1 and 3, between 3 and 5, between 5 and 7, between 7 and 10, between 10 and 15, between 15 and 20 carbon atoms, including any range between. In some embodiments, the alkyl group comprises between 1 and 20, between 1 and 3, between 3 and 5, between 5 and 7, between 7 and 10, between 10 and 15, between 15 and 20 carbon atoms, including any range between.

In some embodiments, the hydrophobic silica particle comprises methyl-silylated silica (C1-silica).

In some embodiments, the hydrophobic silica particle comprises an (C1-C20) haloalkylsilane group bound thereto. In some embodiments, the (C1-C20) haloalkylsilane group comprises a Si bound to at least one C1-C20 haloalkyl, wherein C1-C20 haloalkyl comprises between 1 and 20, between 1 and 3, between 3 and 5, between 5 and 7, between 7 and 10, between 10 and 15, between 15 and 20 carbon atoms, including any range between; and further comprises between 1 and 20, between 1 and 3, between 3 and 5, between 5 and 7, between 7 and 10, between 10 and 15, between 15 and 20 halogen atoms (e.g. Br, Cl, F or any combination thereof).

In some embodiments, the hydrophobic silica comprises a silylated or alkylsilylated silica. In some embodiments, the hydrophobic silica is a fumed silica. In some embodiments, the hydrophobic silica comprises a polysiloxane (e.g., polydimethylsiloxane) grafted to a surface hydroxyl groups of the silica particle. In some embodiments, the hydrophobic silica comprises the chemically modified silica coated by a hydrophobic polymer (e.g., polyolefin, polysiloxane).

In some embodiments, the hydrophobic particle has an average diameter (or cross-section) between 1 and 1000 nm, between 1 and 100 nm, between 1 and 50 nm, between 1 and 10 nm, between 1 and 20 nm, between 10 and 20 nm, between 20 and 40 nm, between 40 and 60 nm, between 60 and 100 nm, between 10 and 1000 nm, between 10 and 100 nm, between 10 and 500 nm, between 100 and 1000 nm, between 100 and 200 nm, between 200 and 500 nm, between 500 and 1000 nm, including any range or value therebetween.

In some embodiments, the hydrophobic particle has an average diameter between 100 nm and 10 μm, between 100 nm and 1 μm, between 100 nm and 5 μm, between 500 nm and 10 μm, between 500 nm and 1 μm, including any range or value therebetween.

In some embodiments, the hydrophobic particle has an average diameter between 1 and 100 μm, between 1 and 10 μm, between 10 and 20 μm, between 20 and 30 μm, between 30 and 40 μm, between 40 and 50 μm, between 50 and 60 μm, between 60 and 70 μm, between 70 and 80 μm, between 80 and 90 μm, between 90 and 100 μm, including any range or value therebetween.

In some embodiments, the terms “average diameter” or “average cross-section” and the term particle size are used herein interchangeably.

In some embodiments, the hydrophobic particle comprises a plurality of hydrophobic particles, wherein each the plurality of hydrophobic particles is characterized by a different chemical composition, a different hydrophobicity and different diameter.

In some embodiments, hydrophobic particles are organized in one or more layer. In some embodiments, the bottom layer comprises hydrophobic particles having a diameter greater than the hydrophobic particles in the top layer.

In some embodiments, the hydrophobic particle is characterized by M-value of 30 to 70, 30 to 40, 40 to 50, 50 to 60, 60 to 70 including any range or value therebetween.

The M-value, as used herein represents the oleophilic degree of the hydrophobic particle. The higher the M-value is, the higher is the hydrophobicity of the particle.

In some embodiments, the hydrophobic coating predetermines a hydrophobicity of the outer surface. In some embodiments, the hydrophobic coating increases the hydrophobicity of the outer surface. In some embodiments, the hydrophobic coating increases water-repellency of the outer surface. In some embodiments, the hydrophobic coating predetermines the CA of the outer surface. In some embodiments, the hydrophobic coating increases the CA of the outer surface. In some embodiments, the hydrophobic coating predetermines the nanometer scale surface roughness, contrary to the micrometer scale surface roughness predetermined by the plurality of craters. In some embodiments, the hydrophobic coating decreases the surface roughness of the outer surface of the superhydrophobic layer.

In some embodiments, the superhydrophobic layer has a thickness between 10 and 200 μm, between 10 and 20 μm, between 20 and 40 μm, between 40 and 50 μm, between 50 and 60 μm, between 60 and 70 μm, between 70 and 80 μm, between 80 and 90 μm, between 90 and 100 μm, between 10 and 500 μm, between 100 and 200 μm, between 200 and 500 μm, including any range or value therebetween.

In some embodiments, the second polymeric layer has a thickness between 10 and 200 μm, between 10 and 20 μm, between 20 and 40 μm, between 40 and 50 μm, between 50 and 60 μm, between 60 and 70 μm, between 70 and 80 μm, between 80 and 90 μm, between 90 and 100 μm, between 10 and 500 μm, between 100 and 200 μm, including any range or value therebetween.

In some embodiments, the first bottom polymeric layer has a thickness between 20 and 200 μm, between 10 and 20 μm, between 20 and 40 μm, between 40 and 50 μm, between 50 and 60 μm, between 60 and 70 μm, between 70 and 80 μm, between 80 and 90 μm, between 90 and 100 μm, between 10 and 500 μm, between 100 and 200 μm, including any range or value therebetween.

In some embodiments, the film of the invention is an extrudate or laminate. In some embodiments, the superhydrophobic layer is an extruded or co-extruded film.

In some embodiments, the film or article of the invention is stretched. in at least one direction. In some embodiments, the film of the invention is stretched along a longitudinal axis of the film (also used herein as Machine Direction Orientation). In some embodiments, stretching ratio is between 1:2 to 1:7, between 1:2 to 1:3, between 1:3 to 1:7, between 1:4 to 1:7, between 1:5 to 1:7, including any range between.

In some embodiments, the superhydrophobic layer is stable at a temperature between −25 and 80° C., between −25 and 0° C., between 0 and 80° C., between 0 and 75° C., between 10 and 80° C., between 10 and 75° C., including any range or value therebetween.

In some embodiments, the superhydrophobic layer is stable upon exposure to UV and/or visible light radiation. In some embodiments, the superhydrophobic layer is stable for at least 12 months, for at least 15 months, for at least 18 months, for at least 20 months, at least 24 months upon exposure to UV radiation of 180 kilo Langley per year (KLy p.a.). In some embodiments, UV stability of the superhydrophobic layer is measured according to an acclimatization test, as described hereinbelow.

As used herein the term “stable” refers to the capability of the perforated layer (e.g. a superhydrophobic layer) to maintain its structural and/or mechanical integrity. In some embodiments, the perforated layer is referred to as stable, if the perforated layer is characterized by a mechanical integrity sufficient to be used as a packaging material. In some embodiments, the perforated layer is referred to as stable, if the perforated layer substantially maintains its structural and/or mechanical integrity under outdoor conditions such as a temperature −25 and 75° C., UV and/or visible light irradiation. In some embodiments, the stable perforated layer is rigid under outdoor conditions. In some embodiments, the stable perforated layer maintains its tensile strength and/or elasticity. In some embodiments, substantially is as described hereinbelow.

In some embodiments, the perforated layer is characterized by elongation at break between 10 and 1000%, between 10 and 20%, between 20 and 30%, between 30 and 40%, between 40 and 50%, between 50 and 60%, between 50 and 100%, between 10 and 100%, between 60 and 100%, between 70 and 100%, between 80 and 100%, between 100 and 1000%, between 100 and 200%, between 200 and 300%, between 300 and 400%, between 400 and 500%, between 500 and 1000%, between 100 and 500%, between 500 and 700%, between 700 and 1000%, including any range or value therebetween.

In some embodiments, the perforated layer is characterized by tensile strength at a break between 5 and 50 N/10 mm, between 5 and 10 N/10 mm, between 10 and 50 N/10 mm, between 10 and 20 N/10 mm, between 20 and 30 N/10 mm, between 30 and 35 N/10 mm, between 35 and 40 N/10 mm, between 40 and 45 N/10 mm, between 45 and 50 N/10 mm, including any range or value therebetween.

In some embodiments, the perforated layer is in contact with an additional layer. In some embodiments, the outer surface of the perforated layer is in contact with a continuous layer. In some embodiments, the inner surface of the perforated layer is in contact with a continuous layer. In some embodiments, the continuous layer comprises one or more layers, wherein the one or more layers have the same or different chemical composition, and/or physical structure. In some embodiments, the continuous layer is a polymeric layer. In some embodiments, the continuous layer comprises one or more polymeric layers.

In some embodiments, a portion of the surface (inner and/or outer surface) of the perforated layer is in contact with a continuous layer. In some embodiments, at least 5%, at least 10%, at least 15%, at least 20%, at least 25%, at least 30%, at least 35%, at least 40%, at least 45%, at least 50% including any range between, of the surface area of the perforated layer is in contact with a continuous layer.

In some embodiments, at most 5%, at most 10%, at most 15%, at most 20%, at most 25%, at most 30%, at most 35%, at most 40%, at most 45%, at most 50%, of an area of the perforated layer is in contact with a continuous layer. In some embodiments, between 1 and 50%, between 1 and 10%, between 10 and 30%, between 5 and 30%, of the surface area (e.g. inner and/or outer surface) of the perforated layer is in contact with a continuous layer including any range between.

In some embodiments, the perforated layer is bound or adhered to the continuous layer. In some embodiments, bound is by a physical interaction a by a non-covalent bond or both.

In some embodiments, the composition or the article of the invention comprises a plurality of layers (e.g. plurality of polymeric layers). In some embodiments, the composition or the article of the invention comprises a first layer comprising the superhydrophobic layer of the invention and a second layer comprising the continuous layer disclosed herein, wherein the first layer and second layer are adhered or bound to each other. In some embodiments, the second layer comprises one or more layers (e.g. polymeric layers).

In some embodiments, article of the invention comprises the perforated layer stably attached to the continuous layer. In some embodiments, the outer surface and/or the inner surface of the perforated layer is stably attached to the continuous layer. In some embodiments, bound is by a physical interaction, by a non-covalent bond or both. In some embodiments, a portion of the outer surface and/or the inner surface of the perforated layer is welded to the continuous layer.

In some embodiments, the continuous layer is a polymeric layer. In some embodiments, the continuous layer comprises a polyolefin, wherein the polyolefin is as described herein. In some embodiments, the continuous layer is substantially devoid of openings, wherein substantially is as described hereinbelow. In some embodiments, the continuous layer is water impermeable. In some embodiments, the continuous layer is substantially devoid of superhydrophobic coating. In some embodiments, the continuous layer comprising polyolefin (e.g. polyethylene) characterized by the same CA and SA as a pristine or unmodified (e.g. non-coated) polyolefin (e.g. polyethylene).

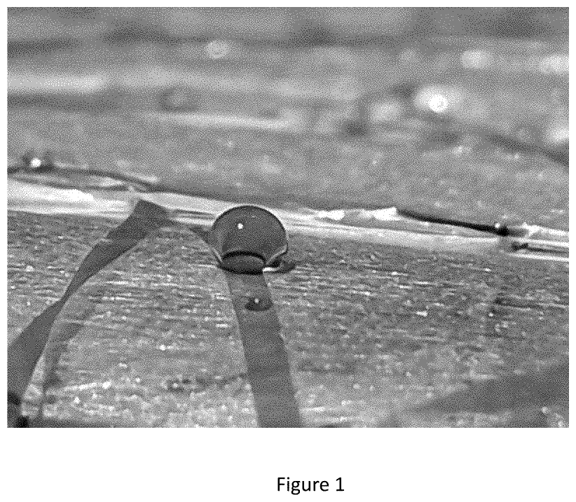

FIG. 1 demonstrates an image of a water droplet on top of the outer surface of an exemplary perforated layer of the invention. As demonstrated by FIG. 1, the water droplet is located on top of the continuous layer (having a sliding angle facilitating water deposition), wherein no water droplets are retained on top of the superhydrophobic perforated layer (having a sliding angle preventing water deposition). The water droplet reflects a typical contact angle of the pristine (e.g. non-superhydrophobic) polyethylene utilized for manufacturing the continuous layer.

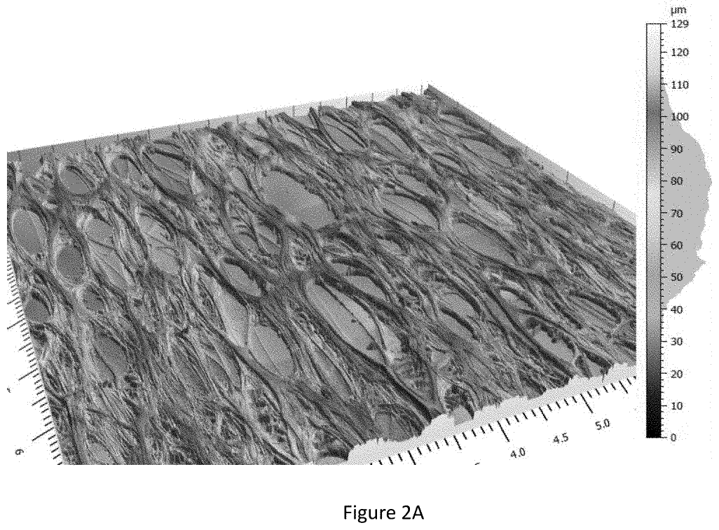

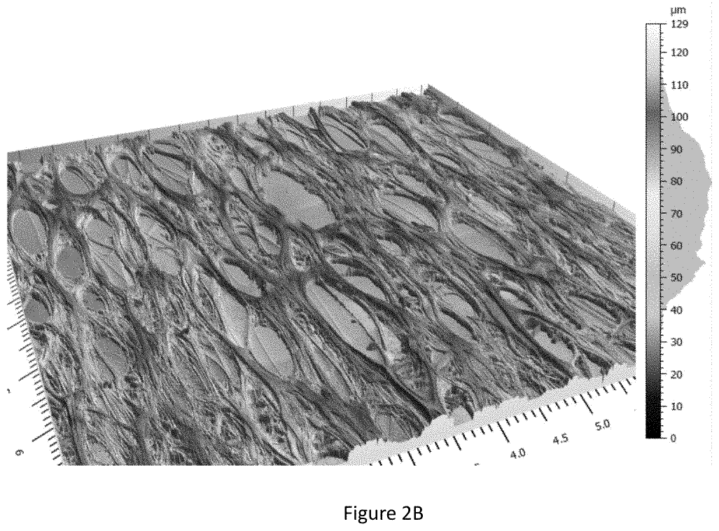

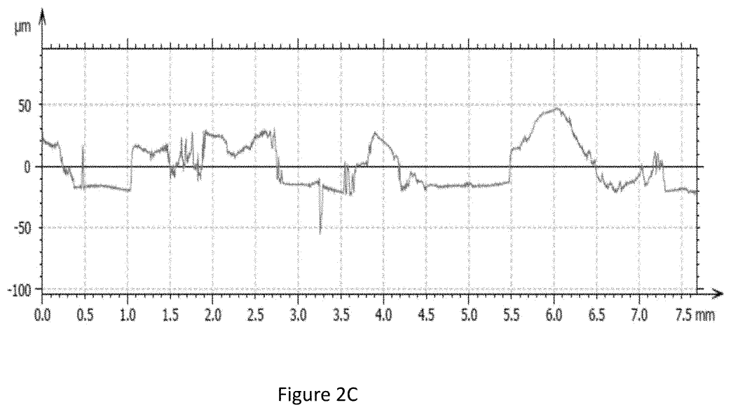

FIGS. 2A-B demonstrate a micrograph of the hydrophobic surface on an exemplary film of the invention obtained using a confocal microscope. The micrographs demonstrate a plurality of craters and peaks distributed on the hydrophobic surface. FIG. 2C demonstrates a profilometer surface analysis in MD direction. In MD direction the peak height values range from about 20 to about 55 um, and the crater depth values range from about 15 to about 50 um. In CD direction the peak height values range from about 20 to about 40 um, and the crater depth values range from about 10 to about 20 um.

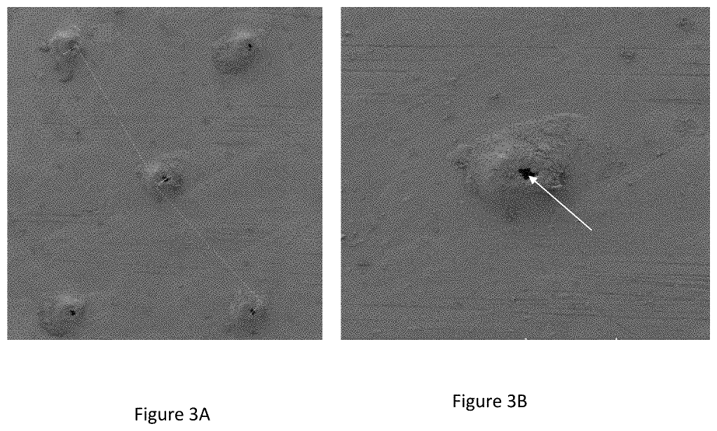

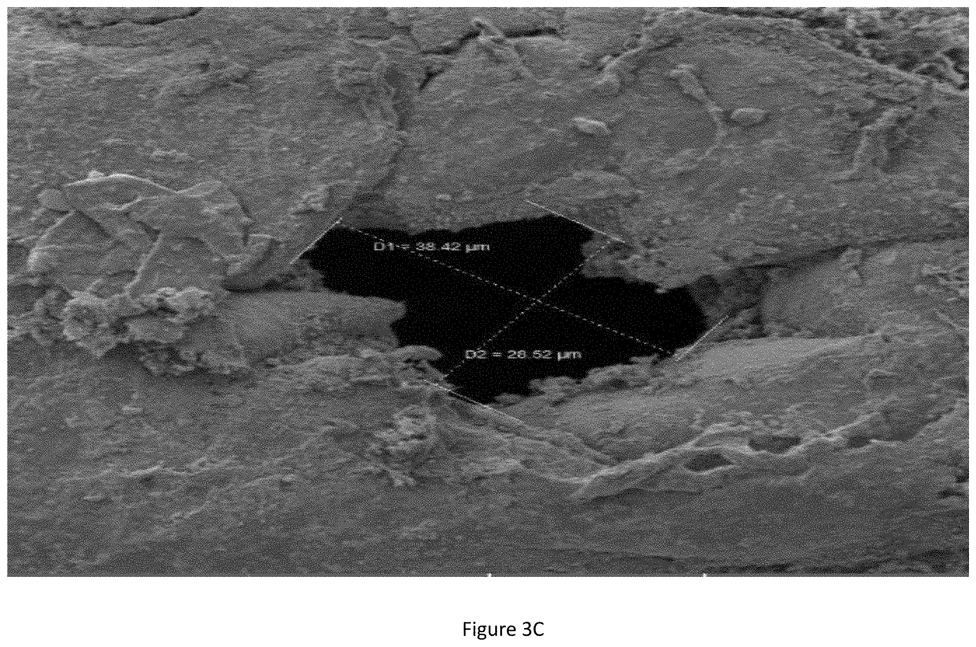

FIGS. 3A-C demonstrate top view Scanning electron microscope (SEM) images of the perforated superhydrophobic layer of an exemplary polyethylene-based film of the invention coated with hydrophobic silica nanoparticles. FIG. 3A represents a plurality of ridges patterned on the surface, wherein each ridge has an opening. As demonstrated by FIG. 3B the conically-shaped ridges have an opening at the top edge or rim of the crater (white arrow). FIG. 3B further demonstrates that the hydrophobic silica nanoparticles form a substantially uniform layer (or coating) on top of the outer surface. The hydrophobic silica nanoparticles are located at valleys (or plain surface), at the rim and on the side walls of the ridges. FIG. 3C represents an enlarged SEM image of an exemplary opening positioned on top of the crater, together with exemplary cross-section dimensions thereof (between about 30 and about 40 um). FIG. 3C further demonstrates that the opening is a void and is not covered by the nanoparticles.

In some embodiments, the continuous layer is in a form of strips or bands. In some embodiments, the continuous layer is in a form of a net. In some embodiments, the continuous layer is in a form of intertwined yarns, threads, fibers or strips. In some embodiments, the continuous layer is in a form of a net having longitudinal franze ribbons interconnected by schuss ribbons.

In some embodiments, the continuous layer is configured for strengthening the film and/or the perforated layer. In some embodiments, the continuous layer increases a mechanical strength (such as tensile strength) of the film and/or of the perforated layer by at least 10%, by at least 20%, by at least 30%, by at least 50%, by at least 70%, by at least 100%, by at least 200%, by at least 300%, by at least 500%, by at least 700%, by at least 1000%, or any value therebetween.

In some embodiments, the continuous layer substantially maintains the shape of the wrapped crop material (e.g. a bale) or of a packaging article.

### Manufacturing Process

According to another aspect of some embodiments of the present invention there is provided a method comprising (i) providing a perforated polymeric layer having an outer surface and an inner surface, wherein the perforated polymeric layer comprises a plurality of openings having a diameter of less than 60 μm; and (ii) contacting the outer surface of the perforated polymeric layer with a plurality of hydrophobic particles under conditions suitable for binding the plurality of hydrophobic particles to the outer surface, thereby manufacturing a superhydrophobic layer having the plurality of hydrophobic particles bound thereto. In some embodiments, the outer surface comprises the superhydrophobic layer. In some embodiments, at least a portion of the outer surface is superhydrophobic. In some embodiments, the outer surface and superhydrophobic layer are as described hereinabove.

In some embodiments, the perforated layer comprises between 30 and 200, between 200 and 400, between 400 and 1000, between 1000 and 2000 openings per square centimeter, wherein a diameter of the openings is less than 60 μm. In some embodiments, the perforated polymeric layer comprises at most 500 openings per square centimeter, wherein a diameter of the openings is less than 60 μm. In some embodiments, a diameter of the openings is as described hereinabove.

In some embodiments, the perforated layer has an outer surface and an inner surface. In some embodiments, the surface morphology of the perforated layer is predetermined by the manufacturing process. In some embodiments, the outer surface of the perforated layer comprises a surface morphology characterized by a plurality of ridges and valleys formed by the plurality of openings, wherein the plurality of ridges and valleys is as described hereinabove.

In some embodiments, the surface morphology described herein is obtained by introducing a blowing agent to the extruded film. In some embodiments, the surface morphology described herein is obtained by any one of: controlled laser ablation, chemical etching, coating etc. In some embodiments, the blowing agent (e.g. an endothermic chemical foaming agent) is added to the thermoplastic polymer at the extrusion step (e.g. both thermoplastic polymer and the blowing agent are introduced into an extruder). In some embodiments, a weight portion of the blowing agent relative to the thermoplastic polymer is between 0.1 and 10%, between 0.1 and 1%, between 0.5 and 10%, between 1 and 10%, between 0.1 and 8%, between 1 and 5%, between 2 and 4%, between 1 and 3%, between 3 and 10%, including any range between.

In some embodiments, the extruded film is exposed to thermal radiation (e.g. in the range of 160-220 C), thereby obtaining the foam-like structure of the outer layer and the surface morphology as described herein.

In some embodiments, a roughness of the outer surface of the perforated layer is substantially greater than a roughness of the inner surface of the superhydrophobic layer, wherein a roughness of the superhydrophobic layer is as described hereinabove. In some embodiments, the diameter or cross-section of the plurality of craters on the outer surface of the perforated layer is in a range, or from 100 to 5000 μm, or from 100 to 300 μm.

In some embodiments, the method is for coating the outer surface of the perforated layer, so as to obtain a superhydrophobic surface having a contact angle of more than 115° and a sliding angle of less than 35°. In some embodiments, the method is for coating the outer surface, so as to obtain a water-repellent surface.

In some embodiments, the method is for manufacturing a superhydrophobic perforated layer characterized by water vapor transmission (WVTR) of at least 300 gr/m²/day. In some embodiments, the method is for manufacturing a superhydrophobic perforated layer characterized by water vapor transmission rate (WVTR) of at least 300 gr/m²/day. In some embodiments, the method is for manufacturing a superhydrophobic perforated layer characterized by water vapor transmission rate (WVTR) of at least 300 gr/m²/day, by a contact angle of more than 115° and by a sliding angle of less than 35°.

In some embodiments, the method is for obtaining a surface having contact angle of more than 115°, more than 120°, more than 125°, more than 130°, more than 135°, more than 140°, more than 145°, more than 150°, including any range or value therebetween.

In another aspect, the method comprises (i) contacting an outer surface of a polymeric layer (e.g. a single layer or a multilayered film) with a plurality of hydrophobic particles under conditions suitable for binding the plurality of hydrophobic particles to the outer surface, thereby manufacturing a superhydrophobic layer; and (ii) perforating the superhydrophobic layer so as to obtain the perforated layer, wherein the perforated layer is as described hereinabove. Various methods of perforating a polymeric layer are known in the art, including inter alia needle punching, mechanical embossing, stretch rupturing, or any combination thereof. Other non-limiting perforating methods include but are not limited to: vacuum forming, LASER, hydroforming, needle punching (hot or cold), hydrosonics, ultrasonics, and any combination thereof.

In some embodiments, the method comprises a step of surface treatment, thereby obtaining a plurality of craters on top of the surface. In some embodiments, the surface treatment is performed by any one of corona treatment, LASER treatment, plasma treatment, and flame treatment or by a combination thereof.

In some embodiments, the method comprises a step of contacting the outer surface of the perforated polymeric layer with a plurality of hydrophobic particles under conditions suitable for binding the plurality of hydrophobic particles to the outer surface, wherein contacting comprises applying a liquid composition comprising the plurality of hydrophobic particles on perforated polymeric layer.

In some embodiments, applying comprises spray coating (warm or cold), flow coating, dipping coating, extrusion coating, transfer coating, electrospray, electrospinning, plasma spraying, printing, and spin coating or any combination thereof.

In some embodiments, the liquid composition is in a form of a solution, an emulsion, a suspension or a dispersion. In some embodiments, the liquid composition is in a form of a Pickering emulsion. Pickering emulsions are well known in the art.

In some embodiments, the liquid composition comprises a polar solvent and the hydrophobic particles. In some embodiments, hydrophobic particles are as described hereinabove.

In some embodiments, the method further comprises exposing the outer surface of the perforated polymeric layer to any of embossing, imprinting, thermal irradiation, microwave irradiation, infra-red irradiation, and UV-visible irradiation, or any combination thereof.

In some embodiments, the method further comprises a step selected from filing and film stretching or both.

According to another aspect of some embodiments of the present invention there is provided a method comprising (i) providing a perforated polymeric layer having an outer surface and an inner surface, wherein the perforated polymeric layer comprises a plurality of openings having a diameter of less than 60 μm; and (ii) exposing the outer surface of the perforated polymeric layer to any of embossing, imprinting, thermal irradiation, microwave irradiation, infra-red irradiation, and UV-visible irradiation, or any combination thereof, to obtain a superhydrophobic layer.

In some embodiments, the perforated polymeric layer is as described hereinabove. In some embodiments, the perforated polymeric layer comprises between 30 and 200, between 200 and 400, between 400 and 1000, between 1000 and 2000 openings per square centimeter, wherein a diameter of the openings is less than 60 μm. In some embodiments, a diameter of the openings is as described hereinabove.

In some embodiments, the method of forming a superhydrophobic layer comprises a step of exposing the outer surface of the perforated polymeric layer to any of compression, imprinting, thermal irradiation, microwave irradiation, infra-red irradiation, and UV-visible irradiation, thereby obtaining a superhydrophobic surface having a contact angle of more than 115° and a sliding angle of less than 35°. Additional methods for obtaining the surface morphology sufficient for inducing formation of the superhydrophobic surface of the invention (e.g. upon coating thereof with hydrophobic metal particles) include but are not limited to: controlled laser ablation, chemical etching, coating, or any combination thereof.

In some embodiments, the superhydrophobic surface is devoid of any hydrophobic particle or coating.

In some embodiments, the method further comprises a step of embossing and/or filing.

In some embodiments, the method is for obtaining a superhydrophobic surface having a contact angle of more than 115° and a sliding angle of less than 35°. In some embodiments, the method is for obtaining a water-repellent surface. In some embodiments, the outer surface is as described hereinabove.

In some embodiments, the method is for manufacturing a perforated layer characterized by water vapor transmission (WVT) of at least 300 gr/m²/day. In some embodiments, the method is for manufacturing a perforated layer characterized by water vapor transmission (WVT) of at least 300 gr/m²/day, wherein at least one surface of the perforated layer is characterized by a contact angle of more than 115° and by a sliding angle of less than 35°.

In some embodiments, the method is for obtaining a surface having a contact angle of more than 115°, more than 120°, more than 125°, more than 130°, more than 135°, more than 140°, more than 145°, more than 150°, including any range or value therebetween.

According to another aspect of some embodiments of the present invention there is provided an article comprising the composition of the invention. In some embodiments, the article is in a form of a film. In some embodiments, the article is in a form of a wrapping material. In some embodiments, the article is in a form of a supply roll of a wrapping material. In some embodiments, the film comprises one or more polymeric layers. In some embodiments, the film or the article comprises a first layer and a second layer, wherein the first layer and the second layer are as described hereinabove (e.g. the perforated layer and/or the water impermeable layer and the continuous layer bound to a portion of the inner surface of the perforated layer).

In some embodiments, the article comprises a plurality of segments. In some embodiments, the plurality of segments are end-to-end joined segments. In some embodiments, the article is compatible or associated with a module forming apparatus. In some embodiments, each of the plurality of segments has at least one dimension (e.g. width, and/or length) compatible with the module forming apparatus. In some embodiments, each of the plurality of segments has a length sufficient for wrapping a module (e.g. cylindrical module) having a pre-selected diameter with a pre-selected number of wraps. In some embodiments, the module comprises a bale of crop material. In some embodiments, each of the plurality of segments has at least one dimension (e.g. width, and/or length) compatible with the module (e.g. bale).

In some embodiments, each of the plurality of segments has a length between 3 and 50 m, between 3 and 5 m, between 5 and 10 m, between 10 and 13 m, between 10 and 12 m, between 12 and 13 m, between 13 and 14 m, between 14 and 15 m, between 15 and 16 m, between 16 and 17 m, between 17 and 18 m, between 18 and 19 m, between 19 and 20 m, between 20 and 25 m, between 25 and 30 m, between 30 and 40 m, between 40 and 50 m, including any range therebetween.

In some embodiments, each of the plurality of segments comprises (1) a first portion comprising the continuous layer, (2) a second portion joined to or in contact with the first portion comprising the perforated layer in contact with the continuous layer, and optionally (3) a third portion comprising the continuous layer, wherein the first portion, the second portion and the third portion are arranged along a longitudinal axis of the segment. In some embodiments, the first portion, the second portion and the third portion are arranged sequentially within the segment. In some embodiments, the first portion and the third portion are substantially devoid of the perforated layer.

In some embodiments, any one of the first portion, the second portion and the third portion has a length between 0.5 and 20 m, between 0.5 and 1 m, between 1 and 2 m, between 2 and 3 m, between 3 and 4 m, between 4 and 5 m, between 5 and 6 m, between 6 and 7 m, between 7 and 8 m, between 8 and 9 m, between 9 and 10 m, between 10 and 15 m, between 15 and 17 m, between 17 and 20 m, including any range therebetween.

In some embodiments, the article is characterized by water vapor transmission rate (WVTR) of at least 300 gr/m²/day. In some embodiments, the article is characterized by a liquid permeability of less than 0.6 gr when measured according to AATCC 35. In some embodiments, the article is characterized by a liquid permeability of less than 0.6 gr and by WVTR of at least 300 gr/m²/day.

In some embodiments, the article is in a form of a packaging material. In some embodiments, the article is in a form of a packaging article. In some embodiments, the packaging material is for wrapping a crop material or a bale. In some embodiments, the packaging material is for packaging an edible matter.

### General

As used herein the term “about” refers to ±10%. Further, all numerical values, e.g. when referring the amounts or ranges of the elements constituting the formulation are approximations which are varied (+) or (−) by up to 10% of from the stated values. It is to be understood, even if not always explicitly stated that all numerical designations are preceded by the term “about”.

The terms “comprises”, “comprising”, “includes”, “including”, “having” and their conjugates mean “including but not limited to”.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure. The term “consisting essentially of” is used to define formulations which include the recited elements but exclude other elements that may have an essential significance on the formulation.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict. The word “optionally” and the word “further” are used herein interchangeably.

The terms, film/films and layer/layers are used herein interchangeably. As used herein, the term “coat” refers to the combined layers disposed over the substrate, excluding the substrate, while the term “substrate” refers to the part of the composite structure supporting the disposed layer/coating. In some embodiments, the terms “layer”, “film” or as used herein interchangeably, refer to a substantially uniform-thickness of a substantially homogeneous substance.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

The inventors successfully manufactured numerous perforated polymeric films (e.g. polyethylene-based films) with a superhydrophobic surface having a contact angle of more than 115° and a sliding angle of less than 35°. The obtained perforated polymeric films showed water repellent properties (see FIG. 1). Furthermore, the perforated films characterized by water vapor transmission (WVTR) of at least 300 gr/m²/day and by a liquid permeability of less than 0.6 gr, when measured according to AATCC 35.

The inventors successfully implemented a superhydrophobic layer having a plurality of hydrophobic nano-particles in contact therewith, for the manufacturing of a film characterized by very low liquid permeability, sufficient strength, and WVTR thus being appropriate for use as the crop wrapping material.

The superhydrophobic layer may be produced using standard extrusion film technologies such as cast or blown film extrusion, and is composed of a polymer, typically a polyolefin and specifically polyethylene for the price/performance combination, but other polymers, such as polypropylene, polyamide, polyurethane have been successfully used. The coating is applied on the extruded film by any of the following methods: coating, dipping, spray coating (warm or cold), flow coating, dipping coating, extrusion coating, transfer coating, electrospray, electrospinning, plasma spraying, printing, and spin coating or any combination thereof.

The perforation can be performed either before or after surface coating. Various methods of perforating a polymeric layer are known in the art, including inter alia needle punching, mechanical embossing, stretch rupturing, or any combination thereof. Other non-limiting perforating methods include but are not limited to: vacuum forming, LASER, hydroforming, needle punching (hot or cold), hydrosonics, ultrasonics, and any combination thereof.

The multi-layered film comprising the superhydrophobic layer bound to an additional support layer, can be produced by means of coextrusion, or added inline or offline with film production through embossing, etching, coating or mechanical abrasion to name a few options.

### Example 1

In an exemplary non-limiting procedure, the hydrophobic silica particles (alkylated or alkylsilylated silica nanoparticles) were applied on the perforated film surface by spread coating. Fumed hydrophobic silica particles, such as Aerosil with an average diameter of between 10 and 20 nm, have been success fully utilized by the inventors.

First a 1-5% dispersion of the hydrophobic silica particles has been formed by adding silica to a liquid (a polar organic solvent and/or an aqueous solvent). Then the dispersion was manually applied on the perforated PE films (having average openings cross-section between about 20 and 40 mm). The perforation can be performed as described above (e.g. by puncturing or via LASER irradiation). Alternatively, the inventors performed perforation after applying the coating.

The perforated films of the invention have been further compared to identical perforated films coated with (i) hydrophilic silica nano-particles; and (ii) hydrophobic silica nano-particles in a combination with a commercial silicon-based surfactant (0.2% of TEGO240 or Loxanol). The results are represented in the Table 1 below.

TABLE 1
CA, water permeability (rain test) and WVTR of the tested films

| | | | WVTR |
|---|---|---|---|
| Sample | CA (θ) | Rain test (g) | (g/24 h × m2) |
| Control 1 | <90° | 0.785 | 626.97 |
| Control 2 | <90° | 0.601 | 721.22 |
| Aerosil 200 | <90° | 0.695 | 485.8 |
| Aerosil 200 | <90° | 1.542 | 671.75 |
| Hydrophobic silica | SH | <0.2 | 487.07 |
| Hydrophobic silica | SH | <0.2 | 604.01 |

SH indicates superhydrophobic; Control 1, 2 indicates a non-coated perforated PE film; Hydrophobic silica indicates exemplary films of the invention manufactured as described hereinabove.

Mixed dispersions containing a silicon surfactant together with hydrophobic particles were inferior and didn't result in stable coatings. Mixed dispersion based coatings have been easily removed by water droplets, most probably due to the dispersing agent.

As demonstrated in Table 1, the superhydrophobic surface of exemplary films of the invention has been characterized by a water contact angle of more than 115° and a sliding angle of less than 35°. Furthermore, exemplary films of the invention films have been characterized by water vapor transmission (WVTR) of greater than 480 gr/m2/day and by a water permeability of less than 0.2 gr, when measured according to AATCC 35.

Based on the results of the experiment, the inventors concluded that hydrophilic silica particles affords a non-hydrophobic surface and does not reduce water permeability of the perforated layer. Accordingly, hydrophobic inorganic nano-particles (e.g. hydrophobic alkylated silica particles) are highly advantageous and result in the formation of superhydrophobic water-repellant surfaces.

While the present invention has been particularly described, persons skilled in the art will appreciate that many variations and modifications can be made. Therefore, the invention is not to be construed as restricted to the particularly described embodiments, and the scope and concept of the invention will be more readily understood by reference to the claims, which follow.

1. A film comprising a perforated layer, wherein at least 95% of openings within said perforated layer are of a diameter of less than 60 μm;
wherein a surface area of said openings is between 0.006 and 10% of the total surface area of said perforated layer;
said perforated layer is characterized by water vapor transmission rate (WVTR) of at least 300 gr/m2/day;
and wherein said perforated layer is characterized by a liquid permeability of less than 0.6 gr when measured according to AATCC 35.

2. The film of claim 1, wherein said perforated layer is in contact with an additional layer.

3. The film of claim 1, wherein said perforated layer comprises a thermoplastic polymer.

4. The film of claim 3, wherein said thermoplastic polymer comprises a polyolefin.

5. The film of claim 1, to wherein (i) said at least 95% of openings have a diameter of between 20 and 60 μm, (ii) a contact angle of an outer surface of said perforated layer is more than 115°, (iii) a sliding angle of said outer surface of said perforated layer is less than 35°, or any combination of (i), (ii), and (iii).

6. The film of claim 1, wherein at least a part of said outer surface of said perforated layer is characterized by a surface roughness of between 100 nm and 10 μm.

7. The film of claim 1, wherein at least a part of said outer surface of said perforated layer comprises a hydrophobic coating bound to the outer surface.

8. The film of claim 6, wherein the hydrophobic coating comprises a plurality of hydrophobic particles.

9. The film of claim 8, wherein said plurality of hydrophobic particles comprises any one of: hydrophobic silica, a hydrophobic titanium oxide, a hydrophobic zinc oxide, and a nano-clay or any combination thereof.

10. The film of claim 9, wherein said hydrophobic silica comprises an alkylated or alkylsilylated silica.

11. The film of claim 8, wherein the hydrophobic particles are characterized by a particle size between 1 and 1000 nm, or between 1 and 100 nm.

12. The film of claim 1, wherein said perforated layer is between 10 and 200 μm thick.

13. The film of claim 1, wherein said perforated layer is stable: (a) at a temperature between −25 to 75° C.; and (b) for at least 12 months upon exposure to UV radiation of 180 kilo Langley per year (KLy p.a.).

14. The film of claim 1, wherein said perforated layer is characterized by elongation at break between 10 and 1000%.

15. The film of claim 1, wherein said perforated layer is characterized by tensile strength at break between 5 and 50 N/10 mm.

16. The film of claim 1, wherein said perforated layer comprises at least 10 openings per square centimeter.

17. The film of claim 1, wherein said perforated layer further comprises an additive.

18. A method of manufacturing the film of claim 1, comprising
(i) providing a perforated polymeric layer having an outer surface and an inner surface, wherein said perforated polymeric layer comprises a plurality of openings having a diameter of less than 60 μm; and (ii) at least one of:
(a) contacting said outer surface of said perforated polymeric layer with a plurality of hydrophobic particles under conditions suitable for binding said plurality of hydrophobic particles to said outer surface; and
(b) exposing said perforated polymeric layer to any of embossing, thermal irradiation, microwave irradiation, infra-red irradiation, and UV-visible irradiation, or any combination thereof;
thereby obtaining said outer surface of the perforated polymeric layer having a contact angle of more than 115° and a sliding angle of less than 35°.

19. (canceled)

20. (canceled)

21. (canceled)

22. An article or a packaging material, comprising the film of claim 1.

23. The article of claim 22, wherein said article is characterized by a) water vapor transmission rate (WVTR) of at least 300 gr/m2/day, b) a liquid permeability of less than 0.6 gr when measured according to AATCC 35, or by a) and b).

24. (canceled)
